(19) United States
(12) Patent Application Publication
(10) Pub. No.: US 2023/0284858 A1
(43) Pub. Date: Sep. 14, 2023

(54) RETROFIT KITS FOR ENABLING AUTONOMOUS OPERATION IN AUTOSCRUBBERS

(71) Applicant: Anram Holdings, Mississauga (CA)

(72) Inventors: Prakash Valentino RAMANAND, Burlington (CA); Jose Miguel BARRIOS SIERRA, Toronto (CA); Romil Hitenbhai DALVADI, Brampton (CA); Rohit VERMA, Gurgaon (IN); Ajay VISHNU, Gurgaon (IN); Harry SAMSON, Gurgaon (IN)

(73) Assignee: Anram Holdings, Mississauga (CA)

(21) Appl. No.: 18/183,622

(22) Filed: Mar. 14, 2023

Related U.S. Application Data
(60) Provisional application No. 63/319,445, filed on Mar. 14, 2022.

(30) Foreign Application Priority Data
Oct. 3, 2022 (IN) 202211056804

(51) Int. Cl. A47L 11/40; G05D 1/02; A47L 11/28

(52) U.S. Cl. CPC A47L 11/4061; G05D 1/0246; A47L 11/28; A47L 11/4011; A47L 2201/04; G05D 2201/0203

(57) ABSTRACT

Embodiments of the present application provide robots and vehicles including a chassis, a drive shaft mounted to the chassis, an integrated steering column, and a set of proximity sensors. The drive shaft may be connected to a drive wheel. The integrated steering column may be operably connected to the drive shaft for steering the drive wheel. The set of proximity sensors may be mounted to the integrated steering column. The set may be configured to scan an ambient environment, where the set includes a first proximity sensor and a second proximity sensor respectively oriented towards each of the opposing lateral sides of the chassis.

### TECHNICAL FIELD

The present application generally relates to systems and methods for autonomous control and operation of robots and vehicles. More particularly, the present application relates to retrofit kits, systems, and methods for enabling an autonomous operation in autoscrubbers.

### BACKGROUND

Various kinds of automatic floor scrubbers, or autoscrubbers, are well known in the cleaning industry. Among those, a ride-on floor scrubber is one of the most commonly used autoscrubbers. The ride-on floor scrubber typically has a seat for an operator, a steering and drive wheel (SDW) assembly, and a brush unit. The operator, usually seated on the seat, manually controls various functions of the ride-on floor scrubber, such as (i) maneuvering the brush unit for cleaning a floor and (ii) controlling the SDW assembly for steering the floor scrubber during operation. However, a manual control of these functions often causes inconsistent use of the ride-on floor scrubber to compromise the efficiency of a cleaning operation. Additionally, the staff required to operate the ride-on floor scrubber is typically unskilled or untrained, leading to a prolonged equipment set-up time, longer or frequent cleaning operation, extensive or repetitive operator training, and increased operational costs. Often, despite such investment of time and resources, the desired cleaning outcome falls short of the expected cleaning standard. Therefore, there is a growing demand for autonomous autoscrubbers to address the above problems.

### SUMMARY

Autonomous autoscrubbers are typically manufactured with preset structural design and chassis specifications to accommodate preset components (e.g., motors, sensors, etc.) required for carrying out intended functions autonomously. However, building the autonomous autoscrubbers from scratch can magnify the time-to-market, manufacturing complexity, and related costs. Alternatively, non-autonomous autoscrubbers can be installed with additional hardware to enable autonomous functionalities. One common approach involves installing independently-controlled torque mechanisms to drive the left and right drive wheels at different torques for autonomous navigation. This approach may fail for the non-autonomous autoscrubbers having a single drive wheel configuration. It may further increase the load on the chassis and various component assemblies mounted thereto (e.g., a wheel and axle assembly) to intensify the wear and tear of the transmission system and the chassis while exacerbating maintenance costs. Other approaches typically require a camera, among other hardware, to enable autonomous navigation in the non-autonomous autoscrubbers. Such camera-reliant approaches for autonomous navigation are computationally intensive, prone to errors due to changes in ambient light conditions, and require costly hardware. Moreover, none of the existing solutions for autonomous control provide to retrofit the non-autonomous autoscrubbers with components enabling the operation of the brush unit without human intervention.

One embodiment of the present application includes an autoscrubber including a chassis, a drive shaft, a power source, and a steering column for steering the autoscrubber. The drive shaft may be mounted to the chassis, where the drive shaft may be connected to a drive wheel. The power source may be mounted to the chassis, where the power source may be configured to propel the drive wheel for moving the autoscrubber. The steering column may be mounted to the chassis. The steering column may include a gearbox shaft, a motor, and a coupler. The gearbox shaft may be mounted into a gearbox. The gearbox shaft may include a tail shaft having a diameter substantially the same as that of a portion of the drive shaft. The motor may be operably connected to the gearbox, where the motor may be configured to provide a torque for rotating the gearbox shaft. The coupler may be configured to connect the tail shaft with the portion of the drive shaft for a conjoint rotation, where the drive shaft may turn the drive wheel about a vertical axis of the gearbox shaft based on a rotation of the gearbox shaft for steering the autoscrubber.

Another embodiment of the present application includes a retrofit kit for autonomously operating a non-autonomous autoscrubber. The retrofit kit may include an integrated steering column, a coupler, a light detection and ranging (LIDAR) sensor, and a wheel encoder. The integrated steering column may be configured to replace a steering column in the non-autonomous autoscrubber. The integrated steering column may include a motor assembly and a control box. The motor assembly may be retrofitted to the non-autonomous autoscrubber. The motor assembly may include a motor, a gearbox shaft, and a motor encoder. The motor may be operably connected to a gearbox. The gearbox shaft may be configured for being mounted into a gearbox, where the gearbox shaft may include a tail shaft having a diameter substantially the same as that of a portion of the drive shaft. The motor encoder may be engaged with the gearbox shaft. The control box may be assembled with the motor assembly, where the control box may include a set of proximity sensors, a presence sensor, and a control unit. The set of proximity sensors may be configured to scan an ambient environment. The set may include a first proximity sensor, a second proximity sensor, and a third proximity sensor located therebetween. The proximity sensors may be oriented away from each other. The presence sensor may be configured to detect motion, where the presence sensor may be located opposite to the third proximity sensor. The control unit may be configured to control at least the motor, encoders, sensors, and actuators provided with the retrofit kit. The coupler may be configured to connect the tail shaft with the portion of the drive shaft for a conjoint rotation. The LIDAR sensor may be retrofitted to the autoscrubber, where the LIDAR sensor may have a field of view extending up to at least 270 degrees in a two-dimensional (2D) plane. The wheel encoder may be retrofitted to the autoscrubber, where the wheel encoder may be mounted to a measuring wheel configured for being in contact with a drive wheel of the autoscrubber.

Yet another embodiment of the present application includes a vehicle comprising a chassis, a drive shaft mounted to the chassis, an integrated steering column mounted to the chassis, and a set of proximity sensors. The drive shaft may be connected to a drive wheel. The integrated steering column may be operably connected to the drive shaft for steering the drive wheel. The set of proximity sensors may be mounted to the integrated steering column. The set may be configured to scan an ambient environment, where the set includes a first proximity sensor and a second proximity sensor respectively oriented towards each of the opposing lateral sides of the chassis.

A further embodiment of the present application includes a retrofit kit for use on a vehicle. The retrofit kit includes an integrated steering column and a coupler. The integrated steering column may be mountable on a chassis of the vehicle and configured to assist in steering the vehicle. The integrated steering column may include a set of proximity sensors configured to scan an ambient environment, where the set may include a first proximity sensor and a second proximity sensor respectively oriented towards each of the opposing lateral sides of the vehicle. The coupler may be configured to mechanically connect the integrated steering column with a drive shaft mounted to the chassis. The drive shaft may be connected to a drive wheel of the vehicle, where the coupler may enable a transfer of torque from the integrated steering column to the drive shaft for steering the vehicle.

Still another embodiment of the present application includes an integrated steering column for a vehicle. The integrated steering column includes a motor assembly and a set of proximity sensors. The motor assembly may include a local shaft adapted to couple with a drive shaft of the vehicle. The motor assembly may be configured to provide a torque to the local shaft, where the local shaft may be rotatable based on the torque to rotate the drive shaft connected to a drive wheel of the vehicle. The set of proximity sensors may be configured to scan an ambient environment. The set may include a first proximity sensor oriented towards a first direction and a second proximity sensor oriented towards a second direction, where the first direction may be opposite to the second direction.

The above summary of exemplary embodiments is not intended to describe each disclosed embodiment or every implementation of the present invention. Other and further aspects and features of the present invention would be evident from reading the following detailed description of the embodiments, which are intended to illustrate, not limit, the present invention.

### BRIEF DESCRIPTION OF DRAWINGS

The illustrated embodiments of the present application would be best understood with reference to the drawings, wherein like parts are designated by like numerals throughout. The following description is intended only by way of example, and simply illustrates certain selected embodiments of devices, systems, and processes that are consistent with the subject matter as claimed herein.

FIG. 1 is a front-left perspective view of a typical non-autonomous ride-on floor scrubber including a traditional steering and drive wheel (SDW) assembly.

FIG. 2 is a typical seat sensor in the typical floor scrubber of FIG. 1.

FIG. 3 is a rear-bottom perspective view of the typical floor scrubber of FIG. 1 illustrating a typical brush unit and a drive wheel.

FIG. 4 is a front-left perspective view of a typical chassis including a drive shaft mounted thereto of the typical floor scrubber of FIG. 1.

FIG. 5 is a typical chassis bracket mounted to the typical chassis of FIG. 4.

FIG. 6 illustrates an exemplary retrofit kit for enabling autonomous operation in the typical scrubber of FIG. 1, according to an embodiment of the present application.

FIG. 7 is an exploded view of an exemplary motor assembly for the retrofit kit of FIG. 6, according to an embodiment of the present application.

FIGS. 8-9 are respective top and bottom views of an exemplary motor gearbox unit for the motor assembly of FIG. 7, according to an embodiment of the present application.

FIG. 10 illustrates an exemplary gearbox shaft for the motor gearbox unit of FIG. 8, according to an embodiment of the present application.

FIG. 11 illustrates an exemplary assembly of the gearbox shaft of FIG. 10, according to an embodiment of the present application.

FIG. 12 illustrates an exemplary motor encoder for the gearbox shaft of FIG. 11, according to an embodiment of the present application.

FIG. 13 illustrates the gearbox shaft of FIG. 11 being aligned with an opening in the motor gearbox unit of FIG. 8, according to an embodiment of the present application.

FIG. 14 is an exploded view of an exemplary coupler for connecting the gearbox shaft of FIG. 11 with the drive shaft of FIG. 4, according to an embodiment of the present application.

FIGS. 15-17 illustrate exemplary steps for assembling together different components of the motor assembly of FIG. 7, according to an embodiment of the present application.

FIGS. 18-19 illustrate exemplary steps for mounting the motor assembly of FIG. 7 to the chassis bracket of FIG. 5, according to an embodiment of the present application.

FIGS. 20-21 illustrate an exemplary mounting system compatible with the motor assembly of FIG. 19, according to an embodiment of the present application.

FIGS. 22-23 illustrate an exemplary control box being mounted to the mounting system of FIGS. 20-21, according to an embodiment of the present application.

FIG. 24 illustrates an exemplary control unit for the control box of FIGS. 22-23, according to an embodiment of the present application.

FIG. 25 is a rear-exploded view of the control box of FIG. 24, according to an embodiment of the present application.

FIGS. 26-27 illustrate an exemplary electronic steering assembly being mounted to the control box of FIG. 24, according to an embodiment of the present application.

FIG. 28 is a front-exploded view of the electronic steering assembly of FIGS. 26-27, according to an embodiment of the present application.

FIG. 29 illustrates different rotational positions of an exemplary steering handle for the electronic steering assembly of FIG. 28, according to an embodiment of the present application.

FIG. 30 is exemplary cover panels being mounted to the motor assembly of FIG. 19 and the control box of FIG. 24, according to an embodiment of the present application.

FIG. 31 is front-right perspective view of an exemplary integrated steering column mounted to the chassis bracket of FIG. 5, according to an embodiment of the present application.

FIG. 32 is a front-right perspective view of the chassis of FIG. 4 including the integrated steering column of FIG. 31 and an exemplary Light Detection and Ranging (LIDAR) sensor, according to an embodiment of the present application.

FIG. 33 is a rear-right perspective view of the chassis of FIG. 32 including an exemplary cleaning sensor, according to an embodiment of the present application.

FIG. 34 is a top perspective view of an exemplary scrubber actuator in a first position for actuating the brush unit of FIG. 3, according to an embodiment of the present application.

FIG. 35 illustrates the brush unit of FIG. 3 in a retracted position based on the scrubber actuator of FIG. 34, according to an embodiment of the present application.

FIG. 36 is a top perspective view of the scrubber actuator of FIG. 34 in a second position, according to an embodiment of the present application.

FIG. 37 illustrates the brush unit of FIG. 3 in an extended position based on the scrubber actuator of FIG. 36, according to an embodiment of the present application.

FIGS. 38-39 are bottom elevation views of the chassis of FIG. 32 illustrating an exemplary brake actuator mounted thereto, according to an embodiment of the present application.

FIGS. 40-42 illustrates an exemplary shaftless encoder unit for the drive wheel of FIG. 3, according to an embodiment of the present application.

FIG. 43 is a front-left perspective view of the typical non-autonomous floor scrubber of FIG. 1 without the SDW assembly, thereby exposing the chassis bracket of FIG. 5.

FIG. 44 is front-left perspective view of an exemplary autonomous autoscrubber including the retrofit kit of FIG. 6 mounted thereon, according to an embodiment of the present application.

FIG. 45 is a rear-bottom perspective view of the autonomous autoscrubber of FIG. 44 including exemplary auxiliary sensors, according to an embodiment of the present application.

FIG. 46 is a front elevation view of the autonomous autoscrubber of FIG. 44, according to an embodiment of the present application.

FIG. 47 is a cross-sectional view of the autonomous autoscrubber of FIG. 44 taken along the line X-X′ in FIG. 46, according to an embodiment of the present application.

FIGS. 48-49 illustrate an exemplary method of learning an exemplary route and an exemplary function of the autonomous autoscrubber of FIG. 44 during a training mode, according to an embodiment of the present application.

FIGS. 50-52 illustrate an exemplary method of autonomously driving the autonomous autoscrubber of FIG. 44, according to an embodiment of the present application.

### DETAILED DESCRIPTION

The following detailed description is provided with reference to the drawings herein. Exemplary embodiments are provided as illustrative examples so as to enable those skilled in the art to practice the application. It will be appreciated that further variations of concepts and embodiments disclosed herein can be contemplated. The examples described in the present application may be used together in different combinations. In the following description, details are set forth in order to provide an understanding of the present application. It will be readily apparent, however, that the present application may be practiced without limitation to all these details in some embodiments. Also, throughout the present application, the terms “a” and “an” are intended to denote at least one of a particular element. The terms “a” and “an” may also denote more than one of a particular element. As used herein, the term “includes” means includes but not limited to, the term “including” means including but not limited to. The term “based on” means based at least in part on, the term “based upon” means based at least in part upon, and the term “such as” means such as but not limited to. The term “relevant” means closely connected or appropriate to what is being done or considered. The term “approximately” or “about” means+/−1%, +/−5%, +/−10%, +/−15%, +/−20% of the stated number or an expected value. The term “substantially” means+/−1%, +/−5%, +/−10%, +/−15%, +/−20%, deviation from an expected value or a target value of an associated parameter.

Further, where certain elements of the present application can be partially or fully implemented using known components, only those portions of such known components that are necessary for an understanding of the present application will be described, and detailed descriptions of other portions of such known components are omitted so as not to obscure the invention(s). In the present application, an embodiment showing a singular component should not be considered limiting; rather, the present application is intended to encompass other embodiments including a plurality of the same component, and vice-versa, unless explicitly stated otherwise herein. Moreover, the applicant does not intend for any term in the present application to be ascribed an uncommon or special meaning unless explicitly set forth as such. The present application also encompasses present and future known equivalents to the components referred to herein.

Embodiments are disclosed in the context of ride-on floor scrubbers; however, one having ordinary skill in the art would understand that the concepts and embodiments described herein may be implemented for various other types of autoscrubbers operable to be controlled manually (e.g., walk-behind, driven or ridden, remote controlled, etc.) and automatically (e.g., operator-triggered, electronically-triggered, etc.). Further, the concepts and embodiments described herein may be implemented on a robot, such as a robotic mobile platform. The robot may include one or more machines, or vice versa. The robot, in certain instances, may include mobile units. Other instances may include the robot operating as a vehicle, or vice versa. In some instances, the robot or the vehicle may include an apparatus (e.g., a robotic arm, a portable or handheld unit, an ultraviolet source unit, etc.). The robot, or parts thereof, may be adapted for any applications such as, without limitation, cleaning, transportation, palletizing, hauling, lifting, elevating, and hoisting. In the present application, the term “cleaning” may refer to cleaning, sweeping, scrubbing, waxing, polishing, wetting, drying, and/or vacuuming a surface. Further in the present application, the term “autoscrubber” may refer to a non-autonomous surface scrubber having at least one electronically controlled functionality. Also, in the present application, the term “by-wire system” or “by-wire kit” may refer to a use of electrical and electromechanical control systems for performing functions that are traditionally achieved by mechanical linkages.

Aspects of the embodiments and concepts disclosed herein, including any variants thereof, may advantageously assist in, at least, (i) transforming robots or vehicles (e.g., ride-on floor scrubbers) from being non-autonomous to autonomous, (ii) switching between an autonomous mode and a non-autonomous mode (e.g., automatic mode, manual mode, training mode, or remote-controlled mode), (iii) providing retrofittable kits for enabling autonomous operation in non-autonomous robots and vehicles, and (iv) providing improved teach-and-repeat modes and methods for autonomous control and navigation.

FIG. 1 is a front-left perspective view of a typical non-autonomous ride-on floor scrubber including a traditional steering and drive wheel (SDW) assembly. The ride-on floor scrubber 10 (hereinafter also referred to as typical scrubber 10) is a non-autonomous mobile robot; however, in certain examples, the typical scrubber 10 may be a non-autonomous vehicle. The typical scrubber 10 has a mobile body 12 having a preset design and structural configuration (e.g., size, cross-sections, dimensions, material strength, number and types of openings, etc.) to functionally and aesthetically accommodate one or more preset components for an operator to manually drive and perform a floor cleaning operation. For example, as illustrated, the typical scrubber 10 has a steering and drive wheel (SDW) assembly, a foot pedal 14, and a seat 16 for an operator. The SDW assembly, among other components, typically includes a conventional steering assembly 18 operationally connected to a drive wheel 30 (shown in FIG. 3). The steering assembly 18 mainly has a steering wheel 20, a steering shaft 22, and a support stand (not shown). The steering shaft 22 is supported by the support stand within a conventional steering column 24. The steering shaft 22 has a top end and a bottom end. The top end is typically connected to the steering wheel 20. The bottom end is typically connected to, or operates as, a drive shaft 50 (FIG. 5). The SDW assembly allows an operator to manually rotate the steering shaft 22 for steering the connected drive wheel 30, e.g., a front wheel. The typical scrubber 10 is powered by an on-board power source 8 such as a battery and an internal combustion engine (ICE). The power source 8 propels the typical scrubber 10, via a transmission system (not shown). While maneuvering the typical scrubber 10, the foot pedal 14 assists the operator in controlling a movement of the typical scrubber 10. The foot pedal 14 is usually connected to the transmission system and a brake assembly (not shown). The foot pedal 14 is manipulated (e.g., pushed or released) manually by the operator. The foot pedal 14 mechanically engages, or disengages, brakes (not shown) with the drive wheel 30 for regulating a speed or movement thereof and hence, that of the typical scrubber 10. The foot pedal 14 is located between the conventional steering column 24 and the seat 16 for the operator.

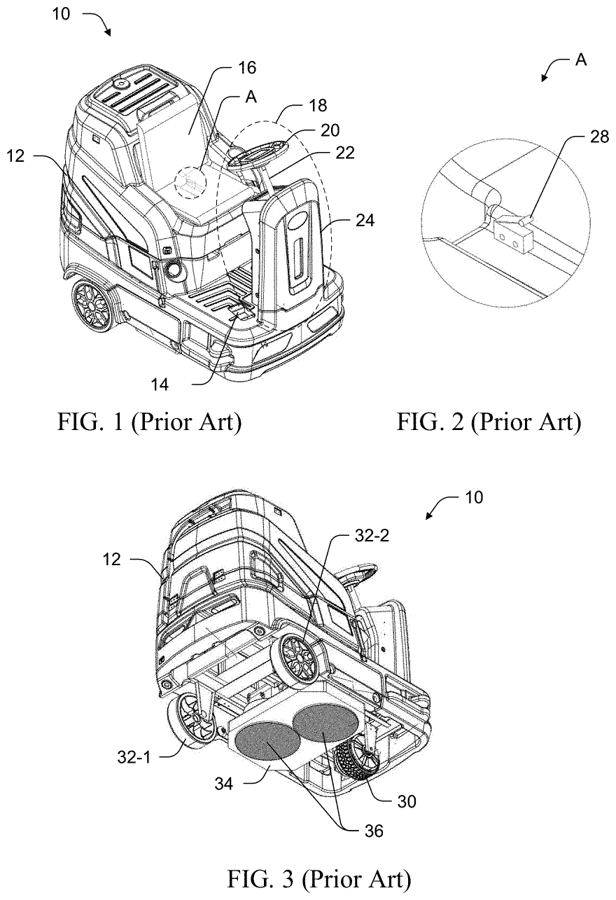

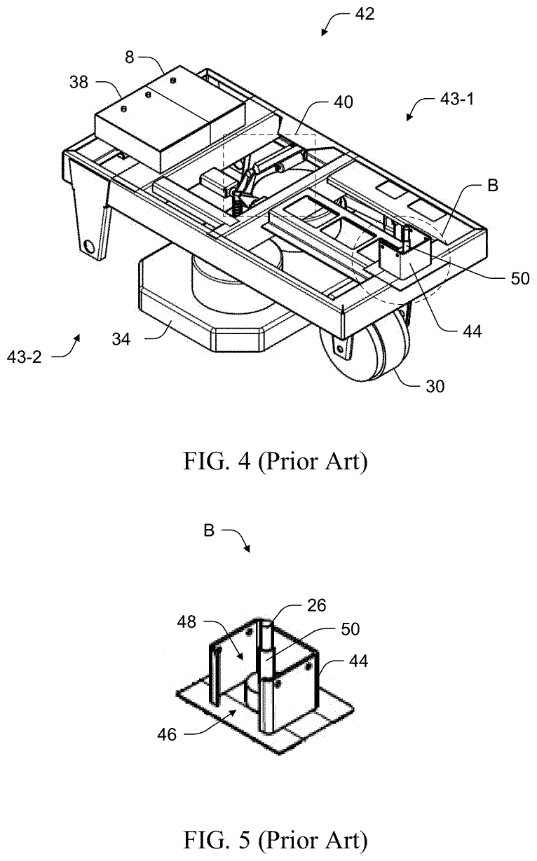

The seat 16 is located proximate to the conventional steering column 24. In some examples, the seat 16 may refer to any platform for supporting or seating the operator while driving the typical scrubber 10. In certain designs, the typical scrubber 10 has the platform for the operator to stand thereon. In some designs, the platform such as the seat 16 has a seat sensor 28 (FIG. 2) located thereunder. The seat sensor 28 (e.g., pressure sensor, heat sensor, contact switch, etc.) generally operates as a safety sensor that senses the seat 16 having the operator seated thereon. The seat sensor 28 typically assists in turning off the onboard power source 8, such as a running engine or a battery supply unit, automatically via an onboard controller 38 (shown in FIG. 4), if the operator leaves the seat 16 for a set duration. As illustrated in FIG. 3, the typical scrubber 10 further has a scrubber assembly and a first non-drive wheel 32-1 and a second non-drive wheel 32-2 (hereinafter collectively referred to as non-drive wheels 32). The non-drive wheels 32 (e.g., rear wheels) are not powered via the transmission system. Unlike the non-drive wheels 32, the drive wheel 30 is propelled by the onboard power source 8 via the transmission system. The drive wheel 30 typically has the brake assembly (e.g., disc brake assembly, a drum brake assembly, etc.) connected thereto. The brake assembly or parts thereof (such as discs brakes or drum brakes) are usually mounted on to a rim of the drive wheel 30 or on a brake shaft (not shown) passing through a center of the rim, thereby occupying a substantial space around the drive wheel 30. The brake assembly is generally driven manually by the operator via the foot pedal 14 to engage or disengage the brakes (not shown) on the drive wheel 30 in the typical scrubber 10.

Further, the scrubber assembly usually has a brush unit 34 having brushes 36. The brush unit 34 is stationary or rotatory in nature. In certain designs, the brushes 36 are stationary, or rotatably attached to the brush unit 34 via a brush motor (not shown). The brushes 36, or the brush unit 34, have any suitable design and include mechanisms for floating on a floor surface when performing the cleaning operation (e.g., during an operation mode) and for being raised from the floor surface during a non-operation mode (e.g., transport mode). For instance, the scrubber assembly has an actuator unit 40 (FIG. 4) for raising or lowering the brush unit 34 (or brushes 36) with respect to the floor. The actuator unit 40 assists in engaging the brushes 36 with the floor surface or disengaging the brushes 36 from the floor surface. The actuator unit 40 is generally operated manually by an operator via a physical lever and/or cable arrangement (not shown). Hence, the actuation of the scrubber assembly, or the brush unit 34, is typically dependent on an input or trigger from the operator. In some configurations, the scrubber assembly, or the brush unit 34, additionally has a vacuum unit (not shown), a cleaning fluid tank (not shown), a recovery tank (not shown), and a squeegee assembly (not shown). The cleaning fluid tank and the recovery tank are fixed, or removable in certain designs. These tanks are generally mounted in the rear section of the typical scrubber 10 or under the seat 16. The squeegee assembly is generally operated manually, or electronically via the onboard controller 38 (shown in FIG. 4) based on an operator input, to release a cleaning fluid from the cleaning fluid tank on to a floor surface. Similarly, the vacuum unit is typically operated manually, or electronically based on an operator input, to extract a dirty solution, or dirt with the cleaning fluid in general, from the floor surface and pass the extracted dirty solution to the recovery tank during the cleaning operation.

Further, as shown in FIG. 4, the typical scrubber 10 includes a chassis 42 for mounting or supporting various components and assemblies, including those mentioned above, thereon. The chassis 42 typically has a predefined structural design and configuration (e.g., size, cross-sections, dimensions, material strength, number and types of openings, etc.) to reliably mount preset components, such as those mentioned above, and support their respective functions in the typical scrubber 10. The chassis 42 has a first lateral side 43-1 and a second lateral side 43-2, hereinafter collectively referred to as lateral sides 43. The chassis 42 generally has a C-shaped bracket 44 (hereinafter interchangeably referred to as chassis bracket 44) mounted thereto. The chassis bracket 44 is located between the lateral sides 43. The chassis bracket 44 typically provides a surface for securing the support stand, which supports the steering shaft 22, therewith. As illustrated in FIG. 5, the chassis bracket 44 typically has a rear open side 46 oriented in a direction towards the seat 16. The chassis bracket 44 defines a C-shaped channel 48 (hereinafter interchangeably referred to chassis channel 48) therein. The chassis channel 48 has the drive shaft 50 extending upwards therethrough. The drive shaft 50 is generally mounted to the chassis 42. The drive shaft 50 has an upper portion 26 and a lower portion (not shown). Typically, the upper portion 26 is physically connected or formed integral to the steering shaft 22. In certain designs, the steering shaft 22 and the drive shaft 50 are the same shaft. The lower portion (not shown) of the drive shaft 50 is connected to the drive wheel 30 either directly or via the transmission system. Further, the chassis 42 supports the onboard controller 38 mounted thereto. The onboard controller 38 controls various general functions and components (e.g., vacuum unit, actuator unit, squeegee assembly, lights, sirens, battery or ICE, etc.) of the typical scrubber 10. Typically, the operator (1) manually steers the typical scrubber 10 using the steering wheel 20 connected to the drive wheel 30 via the steering shaft 22, and (2) manually maneuvers the physical lever to engage, or disengage, the brushes 36 for cleaning the floor.

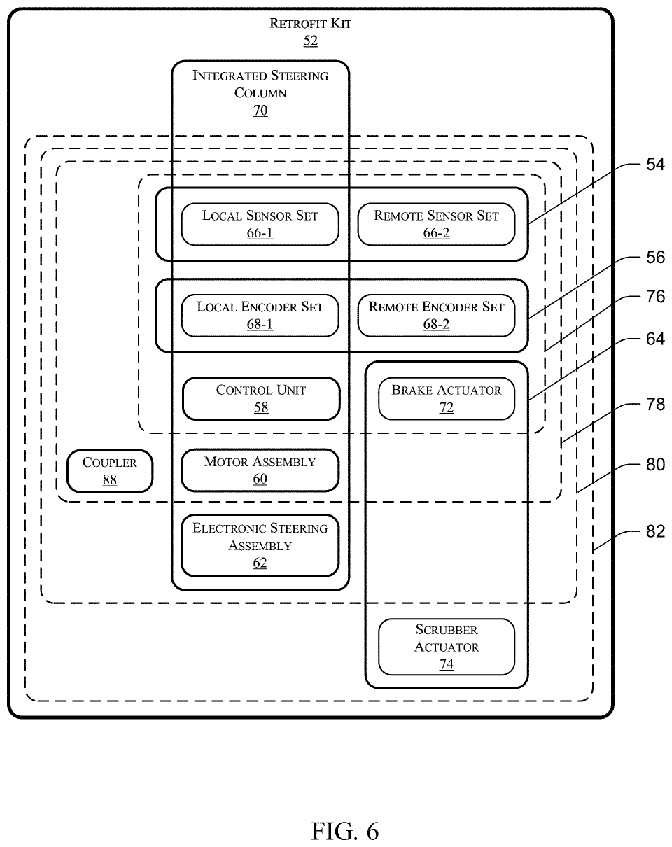

FIG. 6 illustrates an exemplary retrofit kit 52 for incorporating an autonomous functionality in the typical scrubber 10 of FIG. 1, according to an embodiment of the present application. In one embodiment, the retrofit kit 52 may include a collection of components and/or modules retrofittable into the typical scrubber 10. In some examples, the retrofit kit 52 may include multiple sub-kits adapted for being retrofitted, either individually or in any suitable combinations, with the typical scrubber 10 or the chassis 42 thereof. The retrofit kit 52, or a sub-kit thereof in some examples, may be configured for implementing an autonomous functionality in the typical scrubber 10. Hence, the retrofit kit 52, or such sub-kit, may transform the non-autonomous typical scrubber 10 into an autonomous autoscrubber.

In one embodiment, the retrofit kit 52 may include a sensor kit 54, an encoder kit 56, a control unit 58, a motor assembly 60, an electronic steering assembly 62, electromechanical actuators 64, and a coupler 88. The sensor kit 54 may include a local sensor set 66-1 and a remote sensor set 66-2. The encoder kit 56 may include a local encoder set 68-1 and a remote encoder set 68-2. In another embodiment, the retrofit kit 52 may include an integrated steering column 70, the coupler 88, the remote sensor set 66-2, the remote encoder set 68-2, and the electromechanical actuators 64. The integrated steering column 70 may include the local sensor set 66-1, the local encoder set 68-1, the control unit 58, the motor assembly 60, and the electronic steering assembly 62 mounted thereto. In some examples, the integrated steering column 70 may be provided as an assembled single unit configured to replace the conventional steering assembly 18 in the typical scrubber 10. The coupler 88 may be configured to mechanically connect the integrated steering column 70 with the drive shaft 50. In some embodiments, the retrofit kit 52 may include at least one of the control unit 58, the motor assembly 60, and the electronic steering assembly 62 in an unassembled manner.

The electromechanical actuators 64 may be adapted for being mounted (on the typical scrubber 10) remote from the integrated steering column 70. The electromechanical actuators 64 may include any of a variety of suitable types of electromechanical actuators known in the art including, but not limited to, linear actuators and rotary actuators. In one embodiment, the electromechanical actuators 64 may include a brake actuator 72 and a scrubber actuator 74. The scrubber actuator 74 may be configured to assist in driving the brush unit 34, or the brushes 36, autonomously. The scrubber actuator 74 may be a linear actuator in one example; however, any other suitable types of scrubber actuator 74 can be contemplated. The scrubber actuator 74 may be retrofitted in or to the actuator unit 40 of the typical scrubber 10. For example, the scrubber actuator 74 may be adapted to replace a mechanical actuator (e.g., hydraulic actuator) in the actuator unit 40. However, in some examples, the actuator unit 40 may be pre-installed with an electromechanical actuator (similar to the scrubber actuator 74) for triggering the brush unit 34, or the brushes 36. The pre-installed actuator may be reused for implementing an autonomous functionality of the brush unit 34, or the brushes 36, in the scrubber assembly. On the other hand, the brake actuator 72 may be configured to assist in applying, or releasing, the brakes on the drive wheel 30 autonomously. The brake actuator 72 may be a linear actuator in one example; however, any other suitable types of brake actuators can be contemplated. The brake actuator 72 may be retrofitted to the typical scrubber 10 for manipulating the brake assembly either directly or via the foot pedal 14.

In one embodiment, the motor assembly 60 may include a collection of components configured to assist in (i) constructing and/or retrofitting the integrated steering column 70 on to the chassis 42 and (ii) autonomously steering the typical scrubber 100. In some examples, the motor assembly 60 may be configured for being mechanically linked to the drive wheel 30. The motor assembly 60 may be adapted to allow for both autonomous steering and non-autonomous (e.g., manual or remote-controlled) steering. In some examples, the motor assembly 60 may be assembled with the control unit 58 and other components of the integrated steering column 70.

The control unit 58 may be configured to control predefined or dynamically defined functions of various components of the retrofit kit 52. In one example, the control unit 58 may be mounted to or supported by a control box 176 (shown in FIGS. 22-23), discussed below in greater detail. The control unit 58 may be implemented by way of a single device (e.g., a computing device, processor or an electronic storage device) or a combination of multiple devices. The control unit 58 may be implemented in hardware or a suitable combination of hardware and software. For example, the control unit 58 may be configured to execute machine readable program instructions for processing signals received from various components of the retrofit kit 52 and/or those pre-installed on the typical scrubber 10. The control unit 58 may include, for example, microprocessors, microcomputers, microcontrollers, digital signal processors, central processing units, state machines, logic circuits, and/or any devices that may manipulate and output signals based on operational instructions. Among other capabilities, the control unit 58 may be configured to fetch and execute computer readable instructions in communication with a data storage device (not shown). The data storage device may be configured to store, manage, or process signals, instructions, queries, data, and related metadata for implementing or controlling various electrical, electronic, or electromechanical components, including those mentioned above. The data storage device may assist the control unit 58 in facilitating or implementing an autonomous functionality on the typical scrubber 10. The data storage device may be positioned locally with the control unit 58 or remotely therefrom. For example, the data storage device may be located on the typical scrubber 10, e.g., located with the onboard controller 38. In some examples, the data storage device may be located on a remote computing device such as a server and a portable or a wearable computing device. In some other examples, the data storage device may be located on a portable computer-readable medium known in the art.

Further, the data storage device may comprise any suitable computer-readable medium known in the art, related art, or developed later including, but not limited to, volatile memory (e.g., RAM), non-volatile memory (e.g., flash drive), etc., or any combinations thereof. Examples of the data storage device may include, but not limited to, a server, a portable storage device (e.g., a USB drive, a hard drive, access card, etc.), a memory chip or card, and so on. The server may be implemented as any of a variety of computing devices including, for example, a dedicated computing device or a general-purpose computing device, multiple networked servers (arranged in clusters or as a server farm), a mainframe, or so forth. Moreover, in some examples, the control unit 58 may be configured to convert communications (e.g., signals, instructions, queries, data, etc.) received from an entity into appropriate formats compatible with a third-party data application, computing devices, network devices, or interfaces, and vice versa. Examples of the entity include, but are not limited to, (i) a component of the retrofit kit 52 and/or that pre-installed/existing on the typical scrubber 10, (ii) a remote computing device, and (iii) a remote equipment, robot, or vehicle. Hence, the control unit 58 may allow implementation of the data storage device and various components of the retrofit kit 52 using different technologies or by different organizations, e.g., a third-party vendor, managing the components and/or devices using a proprietary technology.

In one embodiment, the control unit 58 may be further configured to control, or operate in tandem with, one or more pre-installed/existing components of the typical scrubber 10 for implementing an autonomous functionality. For example, the control unit 58 may be configured to operate in communication with an existing controller, such as the onboard controller 38, on the typical scrubber 10. In some examples, the control unit 58 may be implemented to replace the onboard controller 38 and configured to additionally perform various predefined functions of the onboard controller 38. In some examples, the control unit 58 may include or coupled to a telemetry circuit (not shown) to communicate with the other components, or remote devices, wirelessly.

In a further embodiment, the control unit 58 may be configured to operate in communication with the sensor kit 54 and the encoder kit 56. The sensor kit 54 including the local sensor set 66-1 and the remote sensor set 66-2 for scanning an ambient environment and/or target surfaces (e.g., floor surface, body or wheels of the typical scrubber 10, etc.). Each of the local sensor set 66-1 and the remote sensor set 66-2 may include one or more proximity sensors. In some examples, the local sensor set 66-1 may include at least one short-range proximity sensor (e.g., ultrasonic sensor, laser sensor, etc.). In other examples, the local sensor set 66-1 may include at least one proximity sensor having a three-dimensional (3D) field of view (FOV) such as an ultrasonic sensor, a camera, and a laser sensor. The local sensor set 66-1 may be adapted for being installed in or with the control box 176 and/or the integrated steering column 70. On the other hand, the remote sensor set 66-2 may be adapted for being installed remotely from the control box 176 and/or the integrated steering column 70. For example, the remote sensor set 66-2 may be adapted for being installed on the scrubber body 12 of the typical scrubber 10 or the chassis 42 thereof. In some examples, the remote sensor set 66-2 may include at least one long-range proximity sensor (e.g., a Light Detection and Ranging (LIDAR) sensor, a camera, etc.). In certain examples, the remote sensor set 66-2 may include at least one proximity sensor having a two-dimensional (2D) field of view. The sensor kit 54 may be adapted to provide inputs to the control unit 58 for implementing an autonomous functionality (e.g., autonomous operation of the scrubber actuator 74, autonomous navigation, etc.) on the typical scrubber 10. In some examples, the sensor kit 54 may further include torque sensors, accelerometers, odometers, gyroscopes, magnetometers, inertial measurement units (IMUs), vision sensors, altitude sensors, temperature sensors, pressure sensors, speedometers, or any other suitable sensors that may assist in implementing, facilitating, or enhancing an autonomous functionality on the typical scrubber 10.

Further to the sensor kit 54, the encoder kit 56 may include the local encoder set 68-1 and the remote encoder set 68-2. Each of the local encoder set 68-1 and the remote encoder set 68-2 may include one or more encoders for providing feedback signals to the control unit 58 based on movements of designated components operatively connected thereto. The local encoder set 68-1 may include at least one encoder adapted for being installed on the integrated steering column 70. The local encoder set 68-1 may be configured to assist in monitoring and/or managing operational states of one or more components of the integrated steering column 70. On the other hand, the remote encoder set 68-2 may be installed remotely from the integrated steering column 70 and configured to assist in monitoring and/or managing operating states of various other components of the typical scrubber 10. In one example, the remote encoder set 68-2 may include at least one encoder for being installed to operate with a designated component (e.g., the drive wheel 30) of the typical scrubber 10, discussed below in greater detail. The encoder kit 56 may assist in implementing and monitoring an autonomous functionality (e.g., autonomous control or autonomous navigation) on the typical scrubber 10. In some examples, the encoder kit 56 may also assist in monitoring a non-autonomous functionality of the typical scrubber 10.

The retrofit kit 52 may further include the electronic steering assembly 62 adapted for constructing, or being retrofitted to, the integrated steering column 70. In one embodiment, the electronic steering assembly 62 may be configured to assist in manual steering and autonomous steering of the typical scrubber 10 via the integrated steering column 70. The electronic steering assembly 62 may be further adapted to provide an indication in response to an autonomous functionality implemented on the typical scrubber 10. In one example, the electronic steering assembly 62 may operate in communication with the control unit 58 and the motor assembly 60. Unlike the conventional mechanical steering assembly 18, the electronic steering assembly 62 may be implemented using a by-wire system.

Further, in one example, the retrofit kit 52 may be adapted to provide a customized kit depending on a type of target equipment (e.g., vehicle or robot, mobile equipment or fixed equipment, etc.). For example, the retrofit kit 52 may be provided as an electronic control kit 76 comprising the control unit 58, the brake actuator 72, the sensor kit 54, and the encoder kit 56. In another example, the retrofit kit 52 may be provided as a robot kit 78 comprising the electronic control kit 76, the motor assembly 60, and the coupler 88. In yet another example, the retrofit kit 52 may be provided as an autodrive kit 80 comprising the robot kit 78 and the electronic steering assembly 62. In a further example, the retrofit kit 52 may be provided as an autoscrubber kit 82 comprising the autodrive kit 80 and the scrubber actuator 74. Each of the electronic control kit 76, the robot kit 78, the autodrive kit 80, and the autoscrubber kit 82 may be configured for being implemented as, or using, a by-wire system.

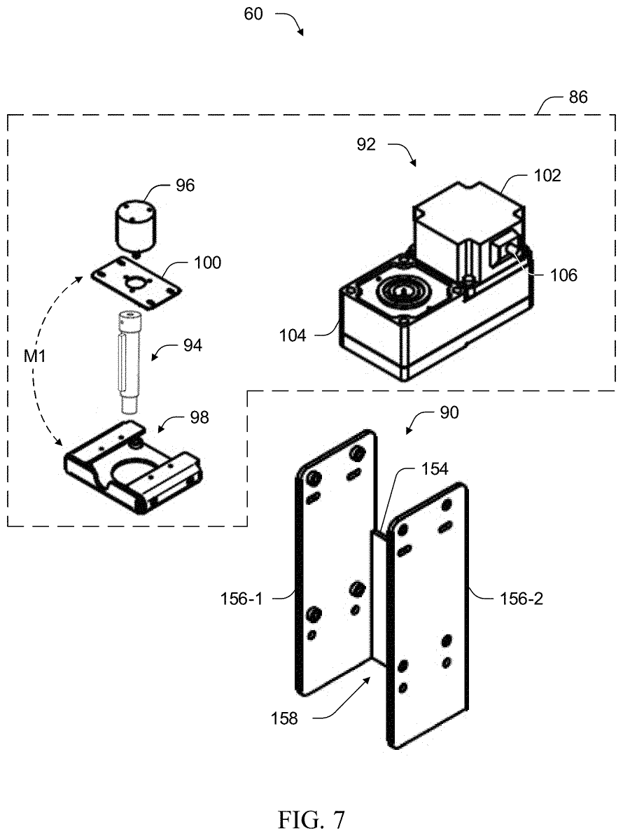

FIG. 7 illustrates an exploded view of an exemplary motor assembly for the retrofit kit of FIG. 6, according to an embodiment of the present application. In one embodiment, the motor assembly 60 may include a motor sub-assembly 86 and a support frame 90. The motor sub-assembly 86 may include a motor gearbox unit 92, a gearbox shaft 94 (i.e., a local shaft) for the motor gearbox unit 92, a motor encoder 96, and a first mounting system M1. The motor gearbox unit 92 may be configured to deliver sufficient torque (with speed control in some examples) for driving the drive shaft 50 via the gearbox shaft 94. The motor gearbox unit 92 may include an electric motor 102 and a gearbox 104 mechanically interconnected thereto via a geartrain (not shown) therein. In some examples, the geartrain may also include one or more intermediate shafts connected thereto. The electric motor 102 may include a motor shaft operating as an input shaft 106. The electric motor 102 may be a brushless, direct current (DC) motor; however, any other suitable types of DC motors known in the art may also be contemplated. The electric motor 102 may be powered by any suitable power source (e.g., battery) and controlled by the control unit 58.

In the illustrated example, the motor gearbox unit 92 may include a right-angled gearbox 104 configured to receive the gearbox shaft 94 perpendicular to the input shaft 106; however, any other suitable configurations for the motor gearbox unit 92 may also be contemplated. For instance, the input shaft 106 may be set to become parallel to the received gearbox shaft 94 depending on an arrangement of gears therebetween, e.g., in the motor gearbox unit 92. In another instance, the input shaft 106 and the gearbox shaft 94 (hereinafter collectively referred to as steering shafts) may be offset from each other, e.g., in the motor gearbox unit 92. In a further instance, the input shaft 106 and the gearbox shaft 94 may be concentrically positioned with respect to each other in the motor gearbox unit 92. Further, in some examples, the motor gearbox unit 92, or the gearbox 104, may operate as a speed reducer configured to increase the torque and reduce a speed of rotation, or vice versa, delivered from the input shaft 106 to the gearbox shaft 94. In some examples, the transfer of torque may depend on a gear ratio of the geartrain between the steering shafts. In one example, the gear ratio may be 50:1 between the steering shafts; however, other suitable gear ratios may be contemplated such as, without limitation, 100:1, 80:1, 60:1, 40:1, 30:1, 20:1, and 10:1. In one example, the motor gearbox unit 92 may adjust the speed of rotation (or the torque) transferred from the input shaft 106 to the gearbox shaft 94 based on a change in the supply voltage applied across the electric motor 102; however, any other suitable techniques known in the art for controlling the motor speed may also be contemplated.

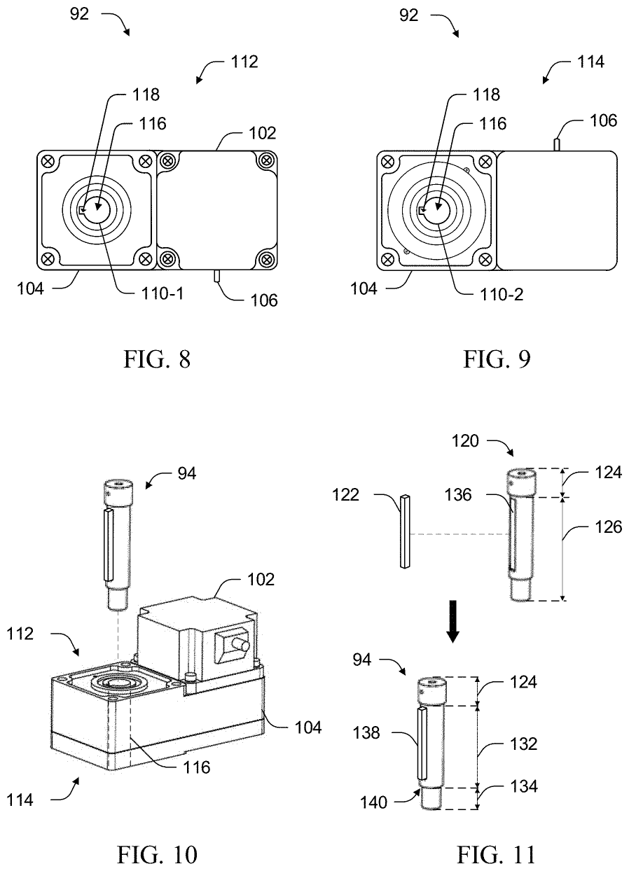

As illustrated in FIGS. 8-9, the gearbox 104 (or the motor gearbox unit 92) may include a first shaft opening 110-1 and a second shaft opening 110-2 (hereinafter collectively referred to as shaft openings 110). Each of the shaft openings 110 may be located on opposing sides of the gearbox 104 (or the motor gearbox unit 92). For example, the first shaft opening 110-1 may be located on a top side 112 of the gearbox 104 (or the motor gearbox unit 92) as shown in FIG. 8 and the second shaft opening 110-2 may be located on a bottom side 114 of the gearbox 104 (or the motor gearbox unit 92) as shown in FIG. 9. The gearbox 104 (or the motor gearbox unit 92) may further include a circular bore 116 extending from the first shaft opening 110-1 to the second shaft opening 110-2. The bore 116 may receive the gearbox shaft 94 via any of the shaft openings 110. In one example (FIG. 10), the gearbox shaft 94 may be removably inserted into the bore 116 via the first shaft opening 110-1 on the top side 112 of the gearbox 104. Further, the bore 116 may include a square-shaped key slot 118 extending outwardly therefrom. In one example, the key slot 118 may be tangentially connected to the bore 116. The key slot 118 may extend between the shaft openings 110. In one example, the key slot 118 may extend longitudinally along the entire length of the bore 116 from the first shaft opening 110-1 to the second shaft opening 110-2; however, some examples may include the key slot 118 having a length less than a length of the bore 116 (or bore length) between the shaft openings 110. In some examples, the key slot 118 may be aligned with a bushing (not shown) connected with the geartrain inside the gearbox 104 (or the motor gearbox unit 92). The bushing may assist in operationally engaging the gearbox shaft 94 with the geartrain via the key slot 118.

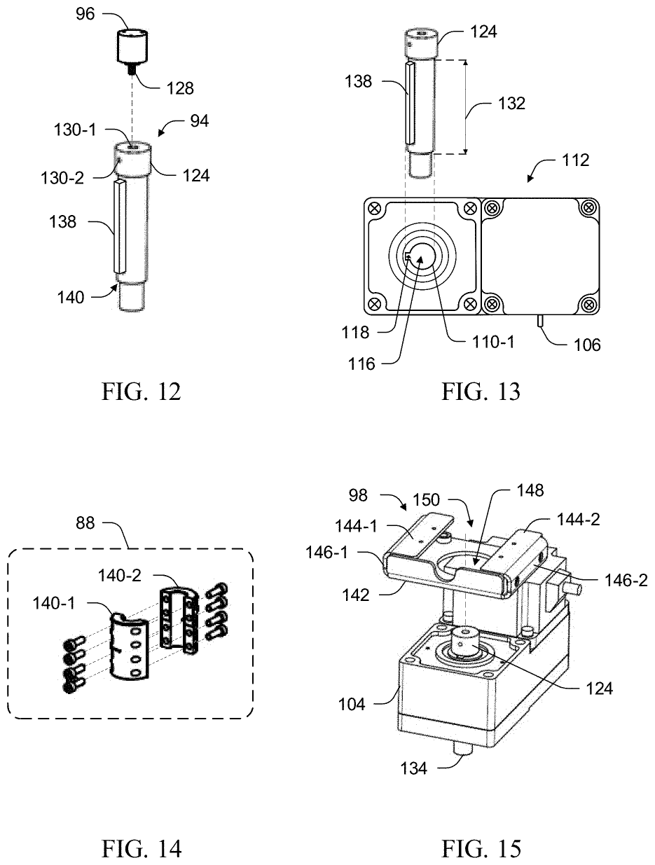

In one embodiment (FIG. 11), the gearbox shaft 94 may be made up of a hollow shaft 120 and a shaft key 122. The hollow shaft 120 may be configured as a step-down shaft including successive parts that reduce a diameter of the hollow shaft 120 (or the gearbox shaft 94) while adding length thereto. In one example, the hollow shaft 120 may include a shaft head 124 and a shaft body 126. The shaft head 124 may have a hollow body. As illustrated in FIG. 12, the shaft head 124 may be adapted to receive the motor encoder 96 from the local encoder set 68-1. The motor encoder 96 may be configured to track a rotation of the gearbox shaft 94 of the gearbox 104 (or the motor gearbox unit 92). In one example, the motor encoder 96 may be implemented as a rotary encoder (i.e., shaft encoder). The motor encoder 96 may include a pin shaft, hereinafter referred to as m-pin shaft 128. The motor encoder 96 may engage with the shaft head 124 via the m-pin shaft 128. In one embodiment, the shaft head 124 may have a first hole 130-1 and a second hole 130-2 (hereinafter collectively referred to as holes 130). The first hole 130-1 may be located on a top surface of the shaft head 124 and may be configured for receiving the m-pin shaft 128 of the motor encoder 96. The second hole 130-2 may be located on a lateral surface of the shaft head 124. The second hole 130-2 may assist in receiving a fastener (e.g., set screw) to secure the m-pin shaft 128 into the first hole 130-1 for engaging the motor encoder 96 with the shaft head 124. The motor encoder 96 may be operatively coupled to the control unit 58 and configured to assist in determining one or more aspects of the gearbox shaft 94, discussed below in greater detail. Examples of these aspects may include, but are not limited to, a number of rotations, a direction of rotation, an angular position (or angle of rotation), and a speed of rotation.

The shaft head 124 may be formed integral to the shaft body 126 or mounted thereto using any suitable connection mechanisms known in the art including, but not limited to, screw fit, gluing, and welding. The shaft head 124 may be cylindrical in shape having a circular cross-section; however, any other suitable cross-sectional shapes may also be contemplated. In one example, the shaft head 124 may be aligned with the shaft body 126 about a common central axis passing therethrough. The shaft head 124 may have a diameter greater than that of the shaft body 126. The shaft head 124 may have a vertical length (or height) less than that of the shaft body 126.

In one embodiment, the shaft body 126 may be chamfered and shaped as a cylinder having a substantially circular cross-section; however, any other suitable cross-sectional shapes may also be contemplated including, but not limited to, elliptical, triangular, polygonal and irregular, depending on the shapes of a receiving shaft opening such as the first shaft opening 110-1 and the bore 116. In some examples, the shaft body 126 may be tapered. Further, in one example, the shaft body 126 may include a midshaft 132 and a tail shaft 134. The midshaft 132 may have a hollow body. The midshaft 132 may be configured for being received within the bore 116 including the key slot 118. In one example (FIG. 11), the midshaft 132 may have a circular cross-section; however, other suitable cross-sectional shapes may also be contemplated depending on the shape of a receiving shaft opening such as the first shaft opening 110-1 and the bore 116. In one example, the midshaft 132 may have a diameter relatively less than that of the shaft head 124. The midshaft 132 may have a length (hereinafter referred to as mid-length) substantially the same as the bore length between the shaft openings 110. In one example, the midshaft 132 may include an elongated slot 136 for receiving the shaft key 122. The elongated slot 136 may extend along a substantial length of the midshaft 132. The elongated slot 136 may have a length relatively less than that of the midshaft 132. The elongated slot 136 may be configured to receive the shaft key 122 lengthwise.

The shaft key 122 may have an elongated body. The shaft key 122 may assist in removably securing the hollow shaft 120 (and the gearbox shaft 94) within the bore 116. The shaft key 122 may have a square cross-section; however, other suitable cross-sectional shapes may also be contemplated. The shaft key 122 may have a length (or key length) relatively less than the mid-length. The key length may be the same as a length of the elongated slot 136. The shaft key 122 may have a width (or key width) the same as a linear width of the elongated slot 136, so that the shaft key 122 may be received into the elongated slot 136. Further, in one example, the shaft key 122 may have a depth (or key depth) less than that of the elongated slot 136 (or an inner diameter of the midshaft 132). The shaft key 122 may be inserted lengthwise partially into the elongated slot 136 to have a portion 138 of the shaft key 122 (or key portion 138) extending outside the elongated slot 136. The key portion 138 may be a longitudinal portion of the shaft key 122. The key portion 138 may have a longitudinal axis parallel to that of the elongated slot 136 (or the midshaft 132) receiving the shaft key 122. In another example, the shaft key 122 may have a depth greater than that of the elongated slot 136 (or the inner diameter of the midshaft 132), so that the key portion 138 may be located outside from the elongated slot 136 when the shaft key 122 may be inserted longitudinally into the elongated slot 136. Other examples may include the shaft key 122 formed integral to the midshaft 132 in a manner that provides the key portion 138 configured as a rib extending outwardly from an exterior surface of the midshaft 132. The key portion 138 may have suitable dimensions and a square cross-section; however, any other suitable cross-sectional shapes may also be contemplated. As shown in FIG. 13, the key portion 138 (or the shaft key 122) together with the midshaft 132 (collectively, referred to as key-midshaft pair) may have a cross-sectional shape the same as that of a receiving shaft opening, such as the first shaft opening 110-1, to insert the key-midshaft pair into the gearbox 104 (or the motor gearbox unit 92). The key portion 138 (or the shaft key 122) may assist in coupling the midshaft 132 (and the gearbox shaft 94) with the geartrain, via the bushing, inside the gearbox 104 (or the motor gearbox unit 92). This coupling may allow a transfer of torque and speed from the input shaft 106 to the midshaft 132 and hence, the gearbox shaft 94. The midshaft 132 may be connected to the tail shaft 134 opposite the shaft head 124.

The tail shaft 134 may be formed integral to the midshaft 132 or connected thereto using any suitable connection mechanisms known in the art including, but not limited to, screw fit, gluing, and welding. The tail shaft 134, the midshaft 132, and the shaft head 124 (or the hollow shaft 120) may be aligned about a common central axis passing therethrough. In one example, the tail shaft 134 may be cylindrical in shape having a circular cross-section; however, any other suitable cross-sectional shapes may also be contemplated. The tail shaft 134 may have a length (or tail length) approximately half of the mid-length. In some examples, the tail length may be less than the mid-length. Other examples may include the tail length being greater than the mid-length. In one example, tail shaft 134 may be configured to have a diameter substantially the same as that of the drive shaft 50, or the upper portion 26 thereof. The diameter of the tail shaft 134 may be less than that of the midshaft 132. The difference in diameters of the tail shaft 134 and the midshaft 132 may form a shoulder 140 therebetween. The shoulder 140 may provide a stop boundary when engaging the tail shaft 134 with the coupler 88. The tail shaft 134 may be configured to concentrically align and/or connect with the upper portion 26 the drive shaft 50 via the coupler 88.

As illustrated in FIG. 14, the coupler 88 may be configured to conjoin or physically couple the tail shaft 134 with the upper portion 26 of the drive shaft 50 (hereinafter collectively referred to as mating shafts) for a conjoint rotation. The coupler 88 may include a first piece 140-1 and a second piece 140-2 (hereinafter collectively referred to as coupler pieces 140); however, other examples may include the coupler 88 being made up of more than two coupler pieces to accommodate any differences in the respective dimensions and cross-sectional shapes of the mating shafts. In one example, the first piece 140-1 may be configured to assemble with and rigidly secured to the second piece 140-2 via set screws; however, any other suitable fasteners or connection mechanisms known in the art may also be contemplated. The coupler pieces 140 may longitudinally align and rigidly connect the tail shaft 134 with the drive shaft 50 in a manner that allows for no relative movement between the mating shafts. Each of the coupler pieces 140 may have a semi-circular inner cross-section, so that the coupler pieces 140, when assembled together, may provide a circular inner cross-section and a hollow space to the coupler 88. The hollow space may have a diameter commensurate with the respective diameters of the mating shafts so that the coupler 88 can hold the mating shafts together reliably. In one example, the inner diameter of the coupler 88 (or the hollow space) may be substantially the same as an outer diameter of the tail shaft 134 and/or the drive shaft 50.

Further, in one example, the motor sub-assembly 86 may also include the first mounting system M1 including a motor bracket 98 and an encoder plate 100. As illustrated in FIG. 15, the motor bracket 98 may be configured for being mounted on the gearbox 104. The motor bracket 98 may be mounted using any suitable connection mechanisms known in the art including, but not limited to, screw fit, luer-lock, gluing, and welding. In one example, the motor bracket 98 may have a length substantially the same or less than that of the gearbox 104 (or the motor gearbox unit 92). The motor bracket 98 may assist in providing an elevated surface above the first shaft opening 110-1 of the gearbox 104 (or the motor gearbox unit 92). In one example, the motor bracket 98 may include a bedplate 142, a first support section 144-1, and a second support section 144-2 (hereinafter collectively referred to as support sections 144), and a first side portion 146-1 and a second side portion 146-2 (hereinafter collective referred to as side portions 146). The bedplate 142 may be substantially planar or flat adapted for being secured to the gearbox 104 (or the motor gearbox unit 92). The bedplate 142 may have a bracket opening 148 in the center. The bracket opening 148 may have a diameter (or a width in some examples) greater than that of the shaft head 124. The bracket opening 148 may be positioned to align with the first shaft opening 110-1, when the bedplate 142 (or the motor bracket 98) may be secured to the gearbox 104 (or the motor gearbox unit 92). In one example, the bedplate 142 may be connected to the support sections 144 via the side portions 146, which may extend forwardly from the bedplate 142.

In the illustrated embodiment, the support sections 144 may extend inwardly from the side portions 146, such that the support sections 144 may be substantially perpendicular to the side portions 146, respectively. In some examples, the support sections 144 may extend inwardly from the side portions 146 in a slightly curved fashion. Each of the support sections 144 may be located in the same horizontal plane. In one example, the support sections 144 may be parallel to the bedplate 142. The support sections 144 and the bedplate 142 may have a preset vertical separation defining a slot (hereinafter referred to as head slot 150) therebetween. The head slot 150 may extend longitudinally between the support sections 144 and the bedplate 142, and laterally between interior surfaces of the side portions 146. The head slot 150 (or the vertical separation) may define an elevation greater than the vertical length (or height) of the shaft head 124. The head slot 150 may be aligned with the bracket opening 148 and provide a horizontal spacing between the support sections 144. The head slot 150 (or the horizontal spacing) may keep the bracket opening 148 exposed for an unobstructed access thereto. In one example, a width of the head slot 150 (or that of the horizontal spacing) may be greater than the diameter of the shaft head 124. Hence, the head slot 150 may assist in receiving the shaft head 124 through the bracket opening 148 when the motor bracket 98 (or the bedplate 142) may be secured to the gearbox 104 (or the motor gearbox unit 92). The support sections 144 may provide a surface to mount the encoder plate 100 thereto.

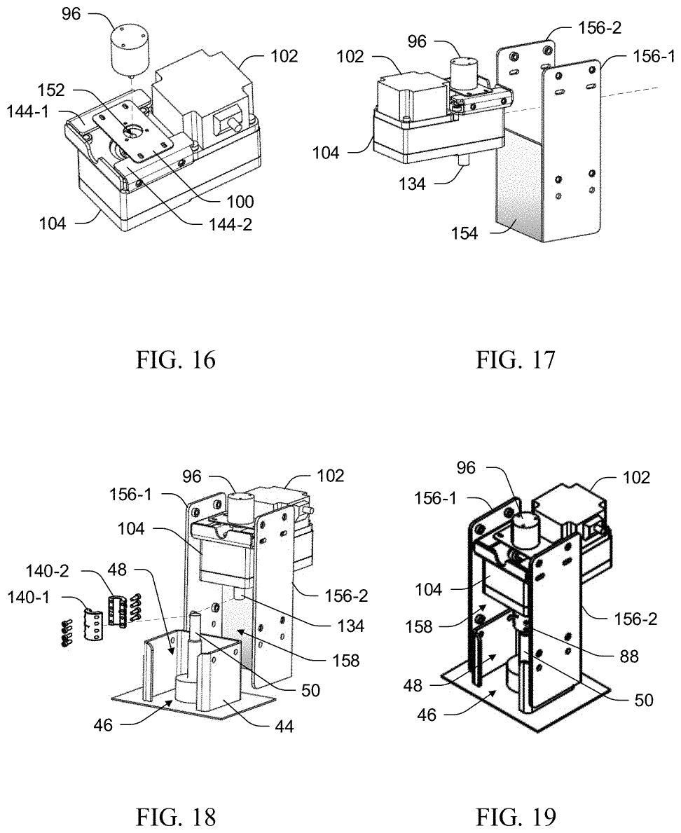

The encoder plate 100 may provide a surface to mount the motor encoder 96 thereto. The encoder plate 100 may have a plate opening 152 in the center. As shown in FIG. 16, the plate opening 152 may be positioned to align with the bracket opening 148 about a common central axis passing therethrough based on the encoder plate 100 being secured to the motor bracket 98 via the support sections 144. The plate opening 152 may allow orienting the m-pin shaft 128 of the motor encoder 96 vertically downward therethrough and towards the bracket opening 148 and the shaft head 124. The encoder plate 100 and the bracket opening 148 (or the bedplate 142 of the motor bracket 98) may have a preset gap therebetween. In some examples, the gap may be predefined based on the elevation provided by the bracket, as discussed above, and a thickness of the encoder plate 100. The gap (and the elevation) may be sufficient for allowing the m-pin shaft 128 of the motor encoder 96 to engage with the shaft head 124 when the encoder plate 100 may be mounted on the gearbox 104 (or the motor gearbox unit 92) via the motor bracket 98. The encoder plate 100 may be secured to the support sections 144 of the motor bracket 98 using any suitable connection mechanisms known in the art including those mentioned above. The encoder plate 100 may have a length substantially the same as that of the motor bracket 98. In some examples, the encoder plate 100 may have a length substantially the same or less than a width of the gearbox 104 (or the motor gearbox unit 92). In further examples, the encoder plate 100 may have a width substantially the same as that of the motor bracket 98.

Further, the motor assembly 60 includes the support frame 90 for mounting the motor sub-assembly 86 thereto. The support frame 90 may also assist in constructing, or assembling, the integrated steering column 70. As illustrated in FIG. 7, the support frame 90 may include a base plate 154, a first side plate 156-1, and a second side plate 156-2. The first side plate 156-1 may be located opposite to the second side plate 156-2. The first side plate 156-1 and the second side plate 156-2 (hereinafter collectively referred to as side plates 156) may extend perpendicular to the base plate 154. In one example, the base plate 154 may have a vertical length relatively less than that of the side plates 156. The base plate 154 along with the side plates 156 may form a C-shaped (or a U-shaped) channel 158 (hereinafter referred to as frame channel 158) therebetween.

As illustrated in FIG. 17, the base plate 154 may have a width sufficient to (i) receive the gearbox 104 (or the motor gearbox unit 92) between the side plates 156 and (ii) engage the side plates 156 with the chassis bracket 44. In one embodiment, as shown in FIG. 18, the assembled motor sub-assembly 86, as discussed above, may be mounted to the support frame 90. The motor sub-assembly 86 including the motor gearbox unit 92 may be oriented to position the gearbox shaft 94 (or the tail shaft 134) in the frame channel 158. The motor sub-assembly 86 may be secured with the support frame 90. For example, the side plates 156 may be secured to the motor bracket 98 in the motor sub-assembly 86 using any suitable connection mechanisms known in the art including those mentioned above. The support frame 90, together with the motor sub-assembly 86, may be mounted to the chassis 42 of the typical scrubber 10. For example (FIG. 19), the support frame 90 may be oriented to position an open side of the frame channel 158 with the rear open side 46 of the chassis bracket 44. In one example, the frame channel 158 may receive the chassis bracket 44 from a lower side (or a lower end) of the support frame 90 for being secured thereto. The received chassis bracket 44 may be secured to the base plate 154 and/or the side plates 156 of the support frame 90 using any suitable connection mechanisms known in the art including those mentioned above.

In the frame channel 158, the tail shaft 134 (or the gearbox shaft 94) of the motor sub-assembly 86 may be vertically aligned with the drive shaft 50 of the typical scrubber 10. In one example, the drive shaft 50 and the tail shaft 134 may have a common longitudinal axis passing therethrough. Tail shaft 134 of the gearbox shaft 94 may be positioned to engage, or almost engage (e.g., separation of less than approximately 5 cm), with the drive shaft 50 within the frame channel 158 based on a length (or height) of the base plate 154 supporting the gearbox 104 (or the motor gearbox unit 92). In one embodiment, the tail shaft 134 may be physically coupled, or conjoined, to the drive shaft 50 via the coupler 88 for a tandem rotation. The coupler 88 enables the transfer of torque from the gearbox shaft 94 to the drive shaft 50 while allowing for no relative movement therebetween. In some examples, the tail shaft 134 or the drive shaft 50 may be also be mounted with, or coupled to, a torque sensor (not shown), operating in communication with the control unit 58, for measuring the torque applied thereto. The torque provided by the gearbox shaft 94 of the motor gearbox unit 92 may be controlled by the control unit 58 or a remote device in communication therewith. The control unit 58 may be located in the control box 176; however, some examples may include the control unit 58 being located elsewhere, e.g., (i) outside the control box 176 on the integrated steering column 70 or (ii) on a remote computing device.

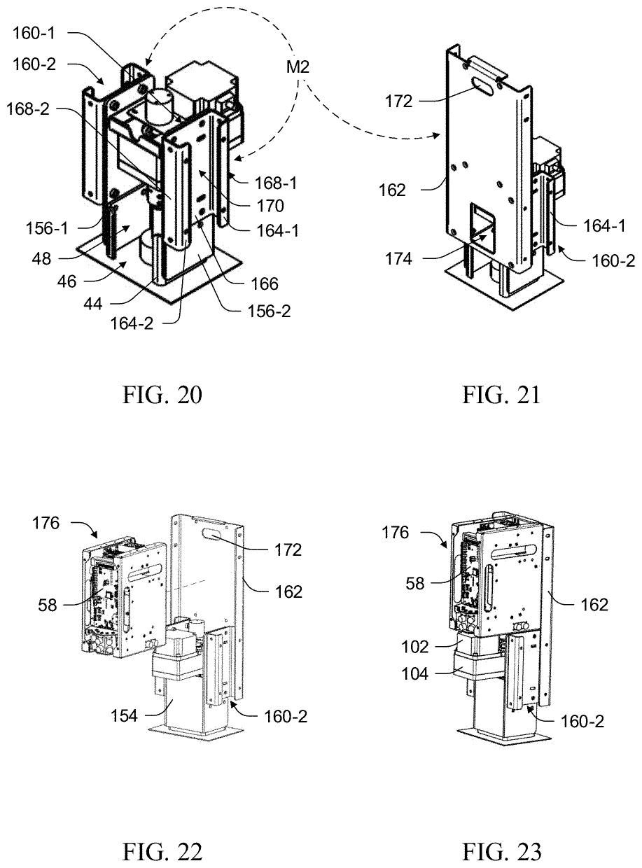

In one embodiment (FIG. 20 and FIG. 21), the retrofit kit 52 may further include a second mounting system (M2) for assembling the control box 176 (shown in FIG. 22) with the motor assembly 60. The second mounting system (M2) may include a first support bracket 160-1, a second support bracket 160-2 (hereinafter collectively referred to as support brackets 160), and a rear panel 162. The support brackets 160 may have a construction similar to that of the motor bracket 98. For the sake of brevity, constructional details of only one of the support brackets 160, e.g., the first support bracket 160-1, are discussed here. One having ordinary skill in the art would understand that other support bracket, e.g., the second support bracket 160-2, may also have a construction and function similar to those of the first support bracket 160-1. For example, the first support bracket 160-1 may include a front support segment 164-1 and a rear support segment 164-2 (hereinafter collectively referred to as support segments 164), and a back plate 166. The back plate 166 may be substantially planar or flat for being secured to the side plate of the support frame 90. The back plate 166 may be connected to the support segments 164 via lateral portions 168-1 and 168-2 (collectively, lateral portions 168). The lateral portions 168 may extend forwardly from the back plate 166. In the illustrated example, the support segments 164 may extend inwardly from the lateral portions 168, such that the support segments 164 may be substantially perpendicular to the lateral portions 168, respectively. The support segments 164 may be located in the same horizontal plane. Each of the support segments 164 may extend along a longitudinal axis of the back plate 166. In one example, the support segments 164 may be parallel to the back plate 166. The support segments 164 and the back plate 166 may have a preset separation defining a slot (hereinafter referred to as air slot 170) therebetween. The air slot 170 may extend laterally between the support segments 164 and the back plate 166, and longitudinally between interior surfaces of the lateral portions 168. The air slot 170 (or the separation) may define a gap for easy circulation of air to cool operational components mounted in and around the motor assembly 60 during operation. The air slot 170 may separate the support segments 164 from each other. Each of the support segments 164 may be individually used to secure different components therewith without hinderance to the separation therebetween. The second support bracket 160-2 may have constructional aspects including support segments 164 and mounting aspects similar to those for the first support bracket 160-1. Each of the support brackets 160 may have a width substantially the same as that of the respective side plates 156 of the support frame 90. In one example, the support brackets 160 may be secured to the side portions 146 of the motor bracket 98 via the side plates 156 of the support frame 90. Each of the support brackets 160, the motor bracket 98, and the side plates 156 may be located in the same horizontal plane parallel to a lateral axis of the chassis 42.

The first support bracket 160-1 may be vertically mounted to the first side plate 156-1 with the support segments 164 extending along a longitudinal axis of the support frame 90. For instance, the front support segment 164-1 may be located proximate to the base plate 154 of the support frame 90 (and a front of the chassis 42 or the typical scrubber 10) when the back plate 166 may be secured to the first side plate 156-1. On the other hand, the rear support segment 164-2 may be located proximate to the rear open side 46 of the chassis bracket 44 (and a rear of the chassis 42 or the typical scrubber 10) when the back plate 166 may be secured to the first side plate 156-1. Similarly, the second support bracket 160-2 may be vertically mounted to the second side plate 156-2 with the corresponding support segments 164 being parallel to the vertical axis of the support frame 90. The support brackets 160 may be configured for supporting the rear panel 162. In one embodiment, the rear panel 162 may be mounted to the support brackets 160. For example, the rear panel 162 may be mounted to the rear support segments (e.g., the rear support segment 164-2) of both the support brackets 160, such that the rear panel 162 may substantially cover the frame channel 158 and at least in-part the chassis channel 48 (or the rear open side 46 of the chassis bracket 44). The rear panel 162 may have a length greater than that of the support frame 90. The rear panel 162 may have an upper section and a lower section. The upper section may include a sensor opening 172 configured to receive or align with a sensor, as discussed below in greater detail. The lower section may include a window 174 for allowing a direct access to the coupler 88 in the frame channel 158 for inspection and maintenance.

As illustrated in FIG. 22, the control box 176 including the control unit 58 may be mounted to the second mounting system M2. For example, the control box 176 may be secured to the rear panel 162 using any suitable connection mechanisms known in the art. As shown in FIG. 23, the control box 176 may be positioned over the motor sub-assembly 86 including the motor gearbox unit 92. In one example, the control box 176 may be supported by the electric motor 102 of the motor gearbox unit 92. The control box 176 may have a width less than that of the rear panel 162 for having a compact configuration and maintaining a smaller footprint of the integrated steering column 70. In some examples, the control box 176 may be positioned between the side plates 156 of the support frame 90. In one example, the upper surface of the control box 176 and that of the rear panel 162 may be located in the same plane. In some examples, the upper surface of the control box 176 may be located below a horizontal plane comprising an upper surface of the rear panel 162. Other examples may include the upper surface of the control box 176 extending above the horizontal plane comprising the upper surface of the rear panel 162 (or the second mounting system M2).

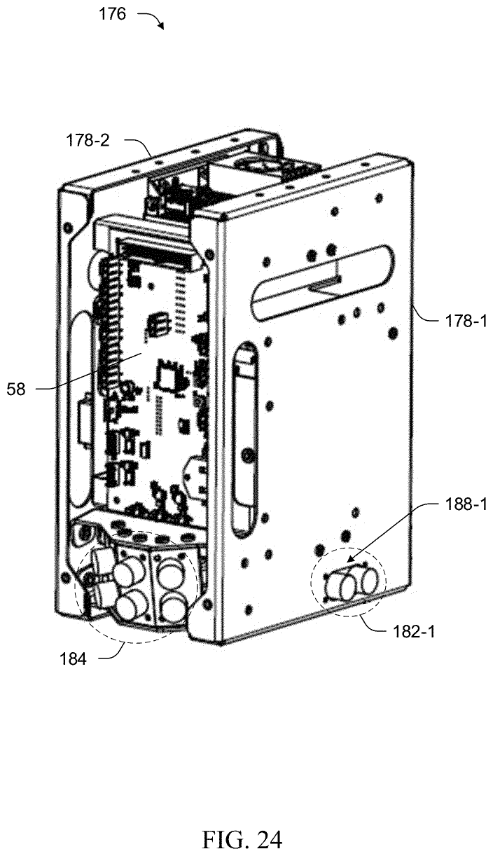

In one example, the control box 176 may refer to a support structure made up of a single housing or multiple plates assembled together for mounting one or more components thereto (hereinafter also referred to as control components). For instance (FIG. 24), the control box 176 may include a first lateral plate 178-1, a second lateral plate 178-2, and a third plate 180 (hereinafter collectively referred to as box plates). Each of the box plates (or the housing) may include one or more openings to avoid obstructing field of views of one or more sensors in the control components mounted therewith. The control components may be configured for enabling and/or controlling an autonomous functionality in the typical scrubber 10 (or the retrofitted scrubber 260). In one embodiment, the control box 176 (or the control components) may include the local sensor set 66-1 and the control unit 58. In one example, the local sensor set 66-1 may be obtained from the sensor kit 54 (or the retrofit kit 52) and mounted to the control box 176.

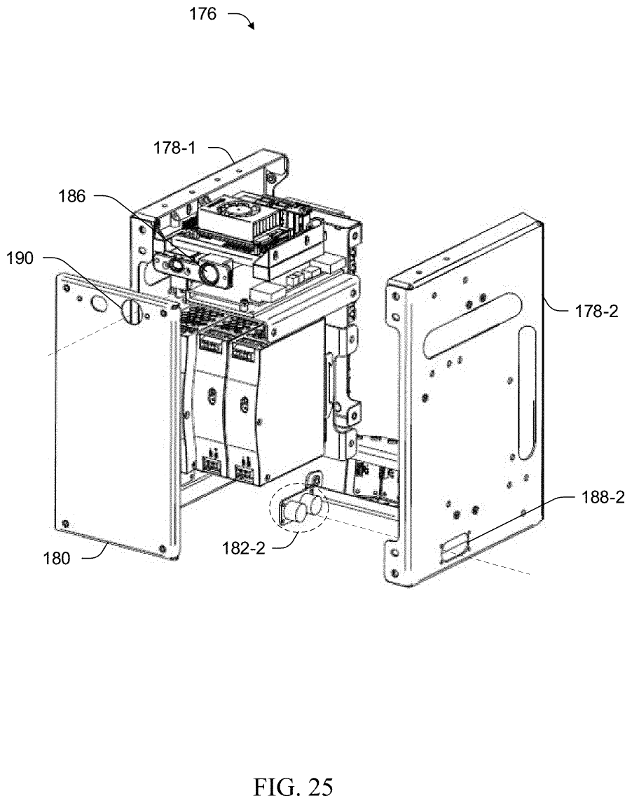

The local sensor set 66-1 may include a set of the same or different types of sensors. For example, when mounted to the control box 176, the local sensor set 66-1 may include a first lateral sensor 182-1, a second lateral sensor 182-2, a front sensor 184 (hereinafter collectively referred to as box sensors) and a rear sensor such as a presence sensor 186. Each of the box sensors may include a set of one or more types of sensors having a 3D field of view. In one example, each of the box sensors may be an ultrasonic sensor having a three-dimensional (3D) field of view and a predefined first range (R1). In one example, the first range (R1) may be approximately 2 meters; however, some examples may include the first range (R1) up to approximately 3 meters. The first lateral sensor 182-1 may be disposed along a right external surface of the control box 176. In one example, the first lateral sensor 182-1 may be mounted in (or extend through) a first lateral opening 188-1 in the first lateral plate 178-1 of the control box 176; however, some examples may include the first lateral sensor 182-1 being mounted on a bracket (not shown) within the control box 176 and aligned with the first lateral opening 188-1. In some examples, the first lateral sensor 182-1 may extend outward from a vertical plane comprising the first lateral plate 178-1 (or the right external surface) of the control box 176. Similarly, a second lateral sensor 182-2 may be disposed along a left external surface of the control box 176. In one example (FIG. 25), the second lateral sensor 182-2 may be mounted in (or extend through) a second lateral opening 188-2 in the second lateral plate 178-2 of the control box 176; however, some examples may include the second lateral sensor 182-2 being secured to a bracket (not shown) within the control box 176 and aligned with the second lateral opening 188-2. In one example, the second lateral sensor 182-2 may extend outward from a vertical plane comprising the second lateral plate 178-2 (or the left external surface) of the control box 176.

The first lateral plate 178-1 (or the right external surface) and the second lateral plate 178-2 (or the left external surface) may be located on opposite sides of the control box 176. In one example, each of the first lateral sensor 182-1 and the second lateral sensor 182-2 (hereinafter collectively referred to as lateral sensors 182) may include a set of one or more box sensors. Each of the lateral sensors 182 may be oriented to have respective field of views in different directions. For example, the first lateral sensor 182-1 may be oriented to have a field of view (fov) in a direction opposite to that of a field of view of the second lateral sensor 182-2. For instance, the first lateral sensor 182-1 may be oriented towards a first direction and the second lateral sensor 182-2 may be oriented towards a second direction, where the first direction may be opposite to the second direction. In another example, the lateral sensors 182 may be oriented towards opposite lateral sides 43 of the chassis 42. For instance, the first lateral sensor 182-1 may be oriented towards the first lateral side 43-1 of the chassis 42 and the second lateral sensor 182-2 may be oriented towards a second lateral side of the chassis 42, where the first lateral side 43-1 may be opposite to the second lateral side 43-2.

Further, the front sensor 184 may be located between the first lateral plate 178-1 and the second lateral plate 178-2 (hereinafter collectively referred to as lateral plates 178). For example (FIG. 24), the front sensor 184 may be mounted on a sensor bracket secured to the lateral plates 178 and located towards a front of the control box 176. In some examples, the front sensor 184 may have a field of view orthogonal to that of at least one of the lateral sensors 182. In some other examples, the front sensor 184 may be oriented in a direction orthogonal to a direction of orientation of at least one of the lateral sensors 182. Further, in one example, the front sensor 184 may be oriented at a downward orientation angle of approximately 10 degrees relative to a longitudinal horizontal axis of the chassis 42 (or the retrofitted scrubber 260); however, other examples may include the front sensor 184 at the downward orientation angle of up to approximately up to 20 degrees relative to the longitudinal horizontal axis of the chassis 42 (or the retrofitted scrubber 260). Due to such downward orientation angle, the front sensor 184 may have a field of view extending towards the ground. Each of the lateral sensors 182 and the front sensor 184 may be removably mounted to the control box 176, e.g., via support brackets, using any suitable connection mechanisms known in the art.

Further, as illustrated in FIG. 25, the control box 176 may include the presence sensor 186 mounted thereto. For example, the presence sensor 186 may be mounted to a support platform (or an inner surface of any of the box plates) within the control box 176. In one example, the presence sensor 186 may be secured to a bracket mounted to the second lateral plate 178-2. The presence sensor 186 may be located opposite to the front sensor 184. In some examples, the presence sensor 186 may be oriented in a direction opposite to a direction of orientation of the front sensor 184. Further, the presence sensor 186 may be positioned in a rear of the control box 176. The presence sensor 186 may be aligned with a rear opening 190 in the third plate 180 of the control box 176. When assembled with the motor assembly 60, the control box 176 may be positioned in a manner that the rear opening 190 and the presence sensor 186 may align with the sensor opening 172 in the rear panel 162 to avoid obstructing the field of view of the presence sensor 186. In one example, the rear opening 190 and the sensor opening 172 may be aligned with each other about a common central axis passing therethrough. In one example, the sensor opening 172, the rear opening 190, and the presence sensor 186 may be located substantially in the same horizontal plane or along the same axis. The presence sensor 186 may include any suitable time-of-flight (TOF) sensors known in the art, related art, or developed later. In one example, the presence sensor 186 may be an ultrasonic sensor. Other examples of the presence sensor 186 may include, but are not limited to, a camera, a light sensor, a LIDAR sensor, and an acoustic sensor, or any combinations thereof.

The presence sensor 186 may be oriented in a direction towards the seat 16. The presence sensor 186 may be configured to detect, at least one of, (i) a motion, (ii) a neutral state of a scrubber surface (e.g., a scrubber platform such as the seat 16), and/or (iii) a change in the neutral state of the scrubber surface (e.g., a scrubber platform such as the seat 16). In one example, the neutral state may refer to an absence of a user (or absence of any motion), or a continuous presence/detection of a stationary or fixed surface/object such as a surface of the seat 16. In some examples, the neutral state may correspond to absence of a motion proximate to a preset scrubber surface (e.g., a scrubber platform such as the seat 16). Each of the box sensors and the presence sensor 186 in the local sensor set 66-1 may be controlled by the control unit 58. As illustrated in FIG. 25, the control box 176 may further include power supplies for powering the local sensor set 66-1, the control unit 58, and other control components in the control box 176. In some examples, the control box 176 may also include the DC power supplies and/or motor driver modules for powering the electric motor 102 in the motor gearbox unit 92. In some examples, the control unit 58 may adjust the DC voltage applied across the electric motor 102, via the motor drive modules, for adjusting the speed of rotation of the input shaft 106 to control the torque applied to the gearbox shaft 94 for rotation thereof. The control unit 58 may be mounted towards the front of the control box 176 for easy access for connections and maintenance; however, any other suitable locations in or along the control box 176 (or the integrated steering column 70) may also be contemplated for the control unit 58. In one example, the control unit 58 may be operatively connected to the local sensor set 66-1 and other control components along with the motor assembly 60 including motor gearbox unit 92, via a by-wire system, for controlling their respective functions. In a further example, the control unit 58 may be configured to operate in communication with a remote computing device via a telemetry unit (not shown). The telemetry unit may be located in the control box or remote therefrom either on the integrated steering column or the typical scrubber 10 (or the retrofitted scrubber 260). The control box and/or the motor assembly 60 may support the electronic steering assembly 62.

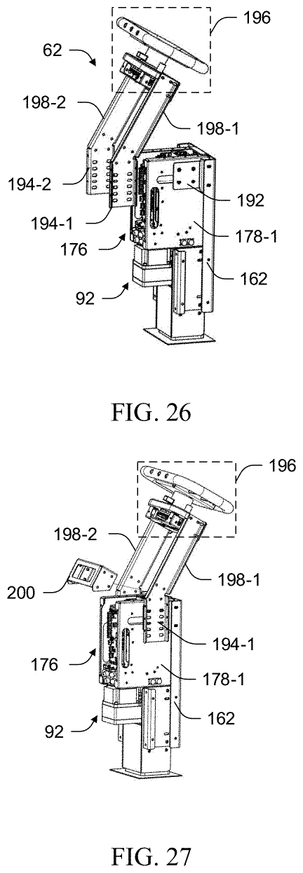

In one example (FIG. 26), the electronic steering assembly 62 may be mounted to the control box 176. The electronic steering assembly 62 may be configured to assist in autonomous steering and/or autonomous navigation of the typical scrubber 10 (or the retrofitted scrubber 260) in communication with the control unit 58. The electronic steering assembly 62 may be also configured for allowing the operator to manually steer the typical scrubber 10 (or the retrofitted scrubber 260). In one example, the electronic steering assembly 62 may include a first support column 194-1, a second support column 194-2 (hereinafter collectively referred to as support columns 194), and a steering unit 196. The support columns 194 may be mounted to the control box 176 via one or more side brackets, such as a side bracket 192. For example, the first support column 194-1 may be mounted to the first lateral plate 178-1 of the control box 176 via the side bracket 192 secured thereto and the rear panel 162. Similarly, the second support column 194-2 may be mounted to the second lateral plate 178-2 of the control box 176 via another side bracket (not shown) secured thereto and the rear panel 162. Each of the support columns 194 may include a tilted portion. For example, the first support column 194-1 may include a first tilted portion 198-1 and the second support column 194-2 may include a second tilted portion 198-2. Each of the first tilted portion 198-1 and the second tilted portion 198-2 (hereinafter collectively referred to as tilted portions 198) may be tilted at a tilt angle of (i) approximately 60 degrees with respect to a horizontal axis of the support columns 194 (or the chassis 42 of the typical scrubber 10) or (ii) approximately 30 degrees with respect to a vertical axis of the integrated steering column 70. Other examples of the tilt angle may include any angle ranging from 0 degrees to approximately 90 degrees with respect to (i) the horizontal axis of the support columns 194 (or the chassis 42 of the typical scrubber 10) or (ii) the vertical axis of the integrated steering column 70. The support columns 194 may be secured to the control box 176 via the respective side brackets using any suitable connection mechanisms known in the art. In one example, the support columns 194 may be secured to have the respective tilted portions 198 tilted to extend in a direction away from the control box 176 and towards the seat 16 (or the rear panel 162). The tilted portions 198 may be parallel to each other when the support columns 194 may be mounted to the control box 176. The tilted portions 198 may provide the operator with comfortable access to the steering unit 196 at an ergonomic position while sitting on the seat 16 and/or riding the typical scrubber 10 (or the retrofitted scrubber 260).

In some examples (FIG. 27), the electronic steering assembly 62 may further include a spacer 200 for the steering unit 196. The spacer 200 may be secured to and between the support columns 194 using any suitable connection mechanisms known in the art. The spacer 200 may provide a rigid support to keep the support columns 194 in position when mounted to the control box 176. The spacer 200 may also assist in resisting jerks and absorbing vibrations during use of the steering unit 196 or motion of the typical scrubber 10 (or the retrofitted scrubber 260). In some examples, the spacer 200 may be formed integral to at least one of the support columns 194. In further examples, the spacer 200 may interface between any of the support columns 194 (or the electronic steering assembly 62) and the control box 176 (or the integrated steering column 70).

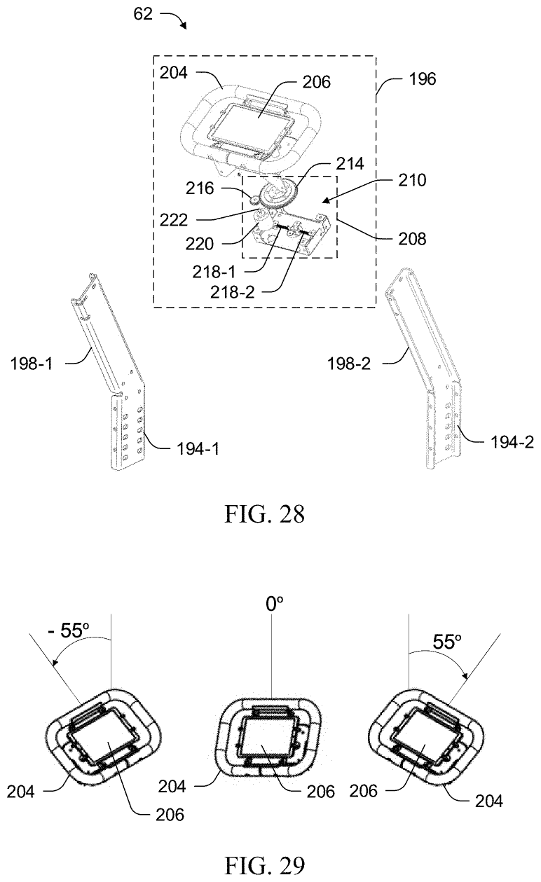

In one embodiment (FIG. 28), the steering unit 196 may be configured to provide steering signals for steering the drive wheel 30. The steering unit 196 may be mounted to the support columns 194. In one example, the steering unit 196 may include a steering handle 204, an interactive display unit 206, and a base unit 208. In one example, the steering handle 204 may have a substantially rectangle-like shape; however, any other suitable shapes may be contemplated including, but not limited to, square-like, circle-like, ellipse-like, trapezium-like, inverted trapezium-like, H-like, U-like, cylinder-like (e.g., bar), polygonal, and irregular. The steering handle 204 may be rotatably mounted to the base unit 208 via a base shaft (not shown). In some examples, the base shaft may be physically disconnected from the drive shaft 50 and the gearbox shaft 94. In one embodiment, the base unit 208 may include a centering mechanism 210 configured to bias (or return) the steering handle 204 towards a preset neutral position. In one example, the centering mechanism 210 may be implemented as a motor-less, or non-motorized, mechanical system to save battery and avoid sophisticated hardware and software programming for implementation. The centering mechanism 210 may include a gear set and a spring set. The gear set may include a single or multiple types of gears. In one example, the gear set may include a large gear 214 and a small gear 216 operationally meshed thereto. The large gear 214, along to other components such as ball bearings (not shown), may be mounted to the base shaft. The large gear 214 may assist in rotation of the base shaft and, hence, the steering handle 204. The large gear 214 may be connected to the spring set including one or more springs. The spring set may operate to bias the steering handle 204 towards the neutral position (or a center position).

In one example, the spring set may include a first extension spring 218-1 and a second extension spring 218-2 (hereinafter collectively referred to as extension springs 218); however, any other different types or number of springs may be implemented depending on the intended design and/or functionality. Each of the extension springs 218 may be operationally connected to the large gear 214, e.g., via a set screw. The first extension spring 218-1 and the second extension spring 218-2 may be located on diametrically opposite sides of the large gear 214. In one example, a clockwise rotation of the steering handle 204 may cause the first extension spring 218-1 to stretch and produce a restoring force urging the steering handle 204 back to the neutral position. Similarly, an anti-clockwise rotation of the steering handle 204 may cause the second extension spring 218-2 to stretch and produce a restoring force urging the steering handle 204 back to the neutral position. The extension springs 218 (or the spring set) may also be configured to control an amount of rotation (or a maximum angle of rotation) of the steering handle 204 depending on the respective predefined spring constants.

In one example, the neutral position may refer to a position at which the steering handle 204 (or a portion or component thereof, e.g., the interactive display unit 206) may have a longitudinal axis parallel to a horizontal axis (or lateral axis) extending along a width of the chassis 42 (or the typical scrubber 10). In another example, the longitudinal axis of the steering handle 204 may be perpendicular to the vertical axis of the typical scrubber 10 (or the integrated steering column 70) in the neutral position. In the neutral position, in one example, the steering handle 204 (or the interactive display unit 206) may have a longitudinal axis parallel to a horizontal plane (or horizontal axis) comprising the support columns 194. As illustrated in FIG. 29, in the neutral position, the steering handle 204 (or the interactive display unit 206 mounted thereto) may be oriented at an angle ranging from zero degrees to approximately 5 degrees with respect to the vertical axis of the steering handle 204 (or the integrated steering column 70). When rotated clockwise, the steering handle 204 may be rotatable to a maximum angle of rotation of 55 degrees relative to the vertical axis of the steering handle 204 (or the integrated steering column 70). Similarly, when rotated anti-clockwise, the steering handle 204 may be rotatable to a maximum angle of rotation of −55 degrees relative to the vertical axis of the steering handle 204 (or the integrated steering column 70). Other examples of the maximum angle of rotation may include any angle from 0 degrees to approximately −90 degrees during the anti-clockwise rotation and 0 degrees to approximately 90 degrees during the clockwise rotation with respect to the vertical axis of the steering handle 204 or the integrated steering column 70. The vertical axis of the steering handle 204 is parallel to the vertical axis of the typical scrubber 10 (or the retrofitted scrubber 260).

In one embodiment (FIG. 28), the base unit 208 may further include a steering encoder 220 mounted to the centering mechanism 210. Similar to the motor encoder 96, in one example, the steering encoder 220 may be implemented as a rotary encoder (or shaft encoder). The steering encoder 220 may include a pin shaft, hereinafter referred to as s-pin shaft 222. The steering encoder 220 may belong to the local encoder set 68-1 in the encoder kit 56 (or the retrofit kit 52). The s-pin shaft 222 may be received by or connected to the small gear 216 meshed with the large gear 214. The meshing between the small gear 216 and the large gear 214 may operationally couple the steering encoder 220 with the base shaft (and hence, the steering handle 204). The steering encoder 220, in communication with the control unit 58, may be configured to assist in determining one or more aspects of the steering handle 204 being rotated. Examples of these aspects may include, but are not limited to, a number of rotations, a direction of rotation (e.g., clockwise or anti-clockwise), an angular position (or angle of rotation), and a speed of rotation.

In one example, the steering handle 204 may include the interactive display unit 206 removably mounted thereto; however, some examples may include the interactive display unit 206 being remote from the steering handle 204. In some examples, the interactive display unit 206 may include a computing device. In some other examples, the interactive display unit 206 or the computing device may be portable or wearable. In a further example, the interactive display unit 206 may include the data storage device in communication with the control unit 58. Other examples may include the interactive display unit 206 being mounted on the scrubber body 12.

In one embodiment, the interactive display unit 206 may be configured to include a software interface for providing actuating signals to the control unit 58 for electronically controlling (i) the typical scrubber 10 (or the retrofitted scrubber 260) and/or (ii) any components, including those of the retrofit kit 52, mounted thereto. Some examples may include the interactive display unit 206 being made stationary or non-rotatable with respect to the steering handle 204. In further examples, the interactive display unit 206, or the steering unit 196, may additionally include any other components (e.g., joysticks, physical buttons, dials, rotary handles, speakers, microphones, light emitting diodes (LEDs), or any combinations thereof, etc.) for constructing, assembling, or operating the electronic steering assembly 62.

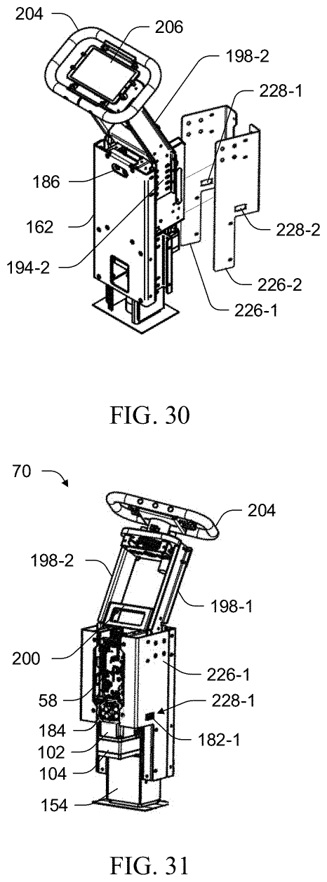

As illustrated in FIG. 30, the electronic steering assembly 62, assembled with the control box 176 and the motor assembly 60, may provide the integrated steering column 70. However, in some examples, the integrated steering column 70 may exclude the electronic steering assembly 62, e.g., when no manual operation of the typical scrubber 10 may be desired, as shown in FIG. 23. Further, in one example, the integrated steering column 70 may also include a set of one or more covers for covering opposing lateral sides of the integrated steering column 70. In one example, the set may include a first cover panel 226-1 and a second cover panel 226-2 (hereinafter collectively referred to as cover panels 226). The first cover panel 226-1 may be secured to the first support column 194-1 and configured to cover the first lateral plate 178-1 of the control box 176 and a portion of the motor assembly 60. In one example, the first cover panel 226-1 may include a first lateral hole 228-1 configured to align with the first lateral sensor 182-1 (and the first lateral opening 188-1) in the control box 176. Similarly, the second cover panel 226-2 may be secured to the second support column 194-2 and configured to cover the second lateral plate 178-2 of the control box 176 and a portion of the motor assembly 60. In one example, the second cover panel 226-2 may include a second lateral hole 228-2 configured to align with the second lateral sensor 182-2 (and the second lateral opening 188-2) in the control box 176.

Each of the first lateral hole 228-1 and the second lateral hole 228-2 (hereinafter collectively referred to as lateral holes 228) may ensure that the respective field of views of the lateral sensors 182 (of the control box 176) remain unobstructed upon mounting the cover panels 226. Further, in one example (FIG. 31), the cover panels 226 may be constructed and/or arranged to keep a front of the control box 176 clear/open and allow the field of view of the front sensor 184 (of the control box 176) remain unobstructed. Other examples may include the cover panels 226 comprising a front panel (not shown) including a front hole aligned with the front sensor 184 of the control box 176. The cover panels 226 may assist in improving aesthetics and protecting various components (e.g., the motor assembly 60 and the control box 176) of the integrated steering column 70.

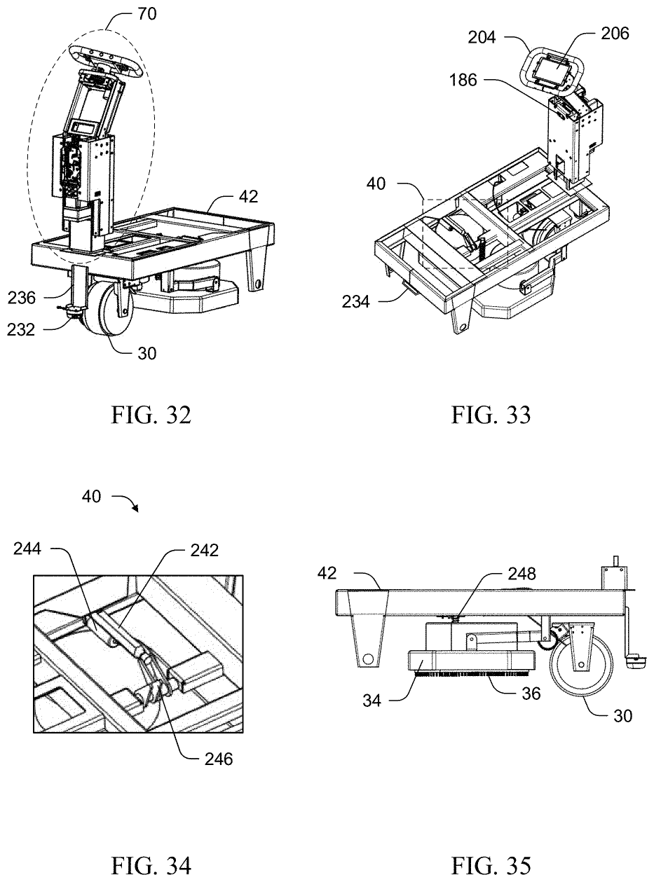

As illustrated in FIG. 32, the integrated steering column 70 including the electronic steering assembly 62, the control box 176, and the motor assembly 60, may be assembled together and mounted to the chassis bracket 44, as discussed above, for retrofitting to the typical scrubber 10. Accordingly, the integrated steering column 70 may be installed to replace the existing steering assembly 18 in the typical scrubber 10. In addition to the integrated steering column 70, the typical scrubber 10 may be retrofitted with the remote sensor set 66-2 from the sensor kit 54 (or the retrofit kit 52). In one embodiment, the remote sensor set 66-2 may include a light detection and ranging (LIDAR) sensor 232 and a cleaning sensor 234; however, other examples may include any different types or number of sensors. In one example, the remote sensor set 66-2 mounted to the typical scrubber 10 may also include an accelerometer, an odometer, a gyroscope, a magnetometer, an inertial measurement unit (IMU), a vision sensor, an altitude sensor, a temperature sensor, a pressure sensor, a speedometer, or any combinations thereof. In some examples, one or more sensors from the remote sensor set 66-2 may also be configured for use as a local sensor and mounted to the integrated steering column 70.

In one embodiment, the LIDAR sensor 232 may be configured as a two-dimensional (2D) LIDAR sensor having a 2D field of view; however, other examples may include any different number and types of long-range proximity sensors known in the art including, but not limited to, cameras and 3D LIDAR sensors. The LIDAR sensor 232 may be implemented as a rotational scanner; however, other examples may include the LIDAR sensor 232 being configured to operate as a non-rotational or stationary scanner. In one example, the LIDAR sensor 232 may be configured to perform a 360-degree scan (also, referred to as an omnidirectional scan). The 2D field of view of the LIDAR sensor 232 may extend in a predefined 2D omnidirectional plane up to a second range (R2), which may be greater than the first range (R1) of at least one of the ultrasonic sensors in the box sensors. In one example, the second range (R2) may be approximately 3 meters; however, some examples may include the second range (R2) extending up to approximately 12 meters. Some examples may include the 2D field of view being directional and extending up to approximately 275 degrees in a 2D plane covering areas straight ahead in the front and those lateral of the typical scrubber 10 (or the retrofitted scrubber 260); however, other examples may include the 2D field of view being greater or less than approximately 275 degrees.

In one embodiment (FIG. 32), the LIDAR sensor 232 may be mounted to a support plate 236 secured to a front side of the chassis 42. In some examples may include the LIDAR sensor 232 being secured to an underside of the chassis 42 and towards the front of the typical scrubber 10 (or the retrofitted scrubber 260). In a further example, the LIDAR sensor 232 may be secured to the scrubber body 12 towards a front of the chassis 42. The LIDAR sensor 232 may be mounted proximate to the front wheel, e.g., the drive wheel 30. The LIDAR sensor 232 may have the field of view, or a portion thereof, extending in a predefined 2D plane up to the second range (R2). In one example, the 2D plane may be parallel to (i) the ground and/or (ii) a horizontal axis (or a longitudinal axis) of the chassis 42 (and the typical scrubber 10). In one example, the LIDAR sensor 232 may be positioned at a height of less than approximately 15 centimeters to assist in detecting small objects and speed breakers along a path being traversed by the typical scrubber 10 (or the retrofitted scrubber 260). Further, in one example, the 2D field of view of the LIDAR sensor 232 may intersect with the 3D field of view of the front sensor 184 in the control box 176. However, in some examples, the 2D field of view of the LIDAR sensor 232 may exclude the 3D field of view of the front sensor 184.

Similar to the LIDAR sensor 232, the chassis 42 may include the cleaning sensor 234 mounted thereto. For example (FIG. 33), the cleaning sensor 234 may be mounted to an underside of the chassis 42 and proximate to a rear of the chassis 42. In some examples, the cleaning sensor 234 may be secured to the scrubber body 12 towards a rear of the chassis 42. In further examples, the cleaning sensor 234 may be mounted to a lateral side of the chassis 42 or the scrubber body 12. Other examples may include the cleaning sensor 234 being mounted to any of the components (e.g., the support frame 90, the control box 176, the cover panels 226, the support columns 194, etc.) of the integrated steering column 70. In one example, the cleaning sensor 234 may be mounted to the chassis 42 at an angle of 45 degrees with respect to a horizontal axis (or vertical axis) of the chassis 42. In some examples, the cleaning sensor 234 may be oriented downwardly at a predefined sensor angle relative to a vertical axis (or horizontal axis) of the chassis 42 or the typical scrubber 10 (or the retrofitted scrubber 260). The sensor angle may be approximately 45 degrees relative to the vertical axis (or the horizontal axis) of the chassis 42 or the typical scrubber 10 (or the retrofitted scrubber 260). Other examples of the sensor angle may include any angle ranging from approximately 5 degrees to approximately 90 degrees with respect to the vertical axis of the chassis 42 or the typical scrubber 10 (or the retrofitted scrubber 260). The cleaning sensor 234 may be oriented to have a field of view extending towards the ground. In one example, the cleaning sensor 234 may be positioned at a height up to approximately 40 centimeters from the ground. In some examples, the cleaning sensor 234, or a part thereof, may be positioned, at least partially, in contact with a surface (e.g., the ground, a wheel, the chassis 42, a cleaning equipment such as the vacuum unit and the squeegee assembly, etc.) to be monitored for dirt, debris, and/or spillage. The cleaning sensor 234 may include any suitable types of sensors known in the art including, but are not limited to, a glossmeter, an oil debris sensor, a metal debris sensor, a camera, a light sensor, or any combinations thereof.

Further to the remote sensor set 66-2, the electromechanical actuators 64 of the retrofit kit 52 may be retrofitted to the typical scrubber 10 (or the retrofitted scrubber 260). In one embodiment, the electromechanical actuators 64 may include the scrubber actuator 74 and the brake actuator 72. In one embodiment, as illustrated in FIG. 34, the scrubber actuator 74 may be an electromechanical linear actuator; however, any other suitable types of linear actuators known in the art configurable for being driven electronically may also be contemplated. In one example, the scrubber actuator 74 may be mounted on the chassis 42 to replace the existing mechanical actuator (e.g., hydraulic actuator) in the actuator unit 40 for raising or lowering the brush unit 34 (or brushes 36). However, in some examples, the typical scrubber 10 may already have an existing electromechanical actuator (similar to the scrubber actuator 74) preinstalled in the actuator unit 40 and operatively connected to the existing onboard controller 38. The preinstalled electromechanical actuator may be reused and configured to perform an intended function of the scrubber actuator 74.

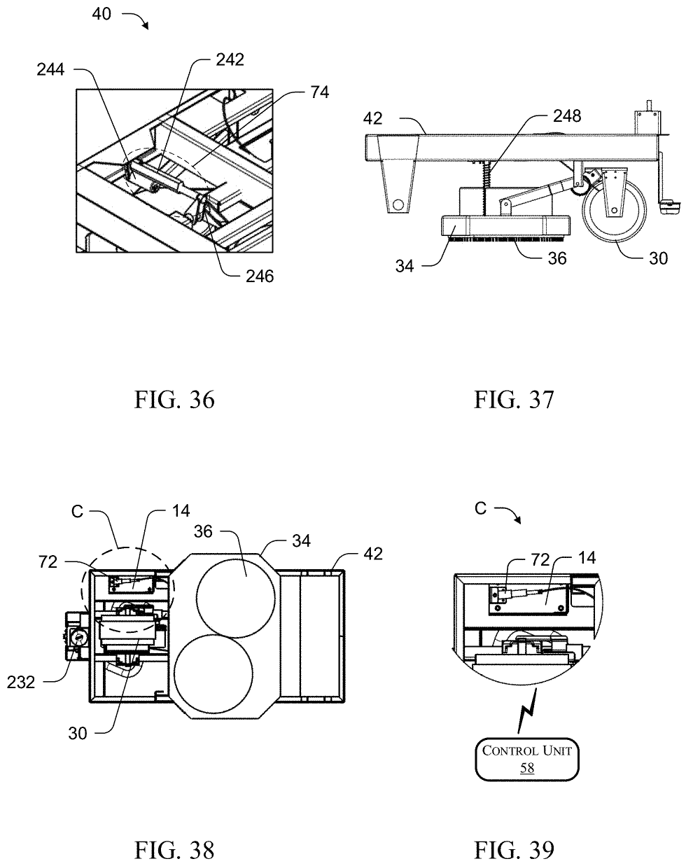

As illustrated (FIG. 34), in one example, the scrubber actuator 74 may include a piston 242 and a servomotor 244. The piston 242 may be operationally connected to a rod 248 for raising or lower the brush unit 34 via a rotary link 246. The servomotor 244 may be configured to drive the piston 242 between a retracted position and an extended position. In the retracted position, the piston 242 may be retracted or moved back towards the servomotor 244. As shown in FIG. 35, the retracted (retracting) piston 242 may move the rotary link 246 to pull-up the rod 248, thereby raising the brush unit 34 to disengage the brushes 36 from the floor. In the extended position (FIG. 36), the piston 242 may extend outwards away from the servomotor 244. As shown in FIG. 37, the extended (or extending) piston 242 may move the rotary link 246 to push down the rod 248, thereby lowering the brush unit 34 to engage the brushes 36 with the floor.

In one embodiment, the scrubber actuator 74 (or the servomotor 244) may be operationally connected to the control unit 58 via an electrical link. The control unit 58 may electronically and autonomously drive the scrubber actuator 74 (or the servomotor 244). In case of the electromechanical actuator already preinstalled on the typical scrubber 10, the preinstalled actuator (similar to the scrubber actuator 74) may be physically disconnected from the onboard controller 38 and operationally connected to the control unit 58 via an electrical link. The control unit 58 may be configured for electronically and/or autonomously driving the preinstalled electromechanical actuator.

Similar to the scrubber actuator 74, the typical scrubber 10 may include the brake actuator 72 mounted thereto. The brake actuator 72 may be a linear actuator; however, any other suitable types of electromechanical actuators known in the art may also be contemplated. As shown in FIGS. 38-39, the brake actuator 72 may be connected to the existing foot pedal 14 via a by-wire system. In one example, the foot pedal 14 may be configured as a dedicated brake pedal to manipulate the brake assembly for applying the brakes to stop the drive wheel 30 when the foot pedal 14 may be pushed, and for releasing the brakes upon taking a foot or pressure away from the foot pedal 14. In another example, the foot pedal 14 may be configured as an accelerator pedal to regulate the power/acceleration for moving the drive wheel 30 based on the foot pedal 14 being pushed, and to manipulate the brake assembly for applying the brakes to stop the drive wheel 30 based on the pressure, or foot, being taken off the foot pedal 14. As shown in FIG. 39, the brake actuator 72 may be operationally connected to the control unit 58 via an electrical link to assist in electronically and/or autonomously actuating or managing the foot pedal 14 for manipulating the brakes. In some examples including a typical autoscrubber with no foot pedal 14, the brake actuator 72 may be connected to the brake assembly either directly or via an existing actuating component (e.g., hand brake, hand lever, etc.). The brake actuator 72 may be controlled by the control unit 58 for electronic or autonomous braking.

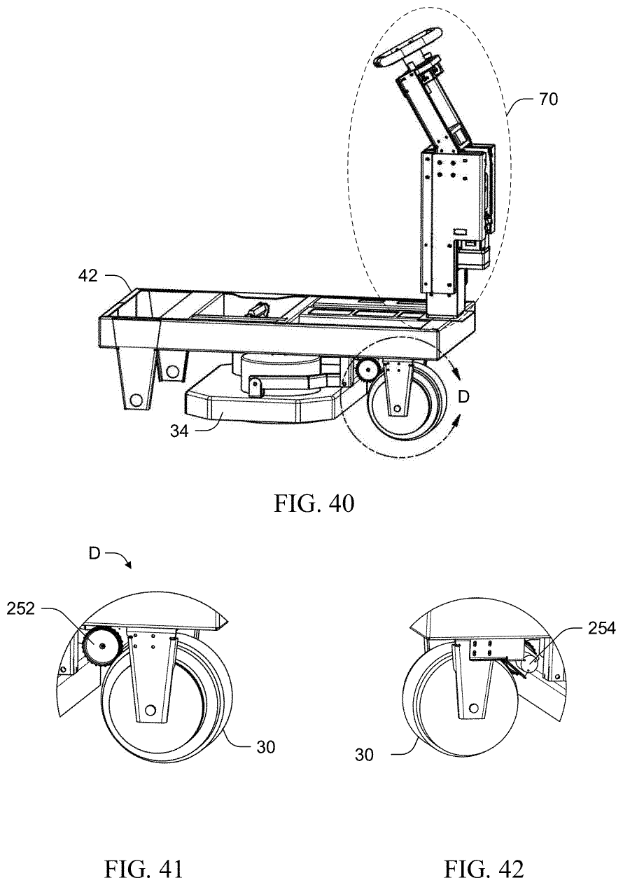

Further, similar to the electromechanical actuators 64, the remote encoder set 68-2 may be retrofitted to the typical scrubber 10. In one example, the remote encoder set 68-2 may be obtained from the encoder kit 56 (or the retrofit kit 52). In one embodiment (FIG. 40), the remote encoder set 68-2 may include a shaftless encoder unit for monitoring a spin of a wheel, such as the drive wheel 30. In one example (FIG. 41), the shaftless encoder unit may include a measuring wheel 252 pivotally attached to a support arm (not shown). The shaftless encoder unit may further include a shaftless wheel encoder 254 implemented as a rotary encoder (or shaft encoder). The wheel encoder 254 may be similar in construction and operation to the motor encoder 96 or the steering encoder 220, as discussed above. In one example (FIG. 42), the wheel encoder 254 may be mounted to the measuring wheel 252. Further, the support arm may be secured to the chassis 42 towards a front of the chassis 42. For example, the support arm may be mounted to an underside of the chassis 42 near the drive wheel 30, e.g., the front wheel, for movably mounting the measuring wheel 252 in contact with an outer surface of the drive wheel 30, where this outer surface touches the floor. Due to the measuring wheel 252 being operable to pivot with respect to the support arm, the wheel encoder 254 may be advantageously mounted to the measuring wheel 252 independent of a width of the drive wheel 30 and a type of brake components (e.g., drum brake, disc brake, etc.) mounted thereto. Hence, the shaftless measuring wheel 252 (and hence, the shaftless wheel encoder 254) may be arranged in contact with the outer surface of the drive wheel 30, irrespective of a width/thickness of the drive wheel 30, and avoid any interference with the braking components that are typically mounted on the drive wheel 30. The wheel encoder 254 may be operatively coupled to the control unit 58 via an electrical link (e.g., electrical cable or wire, data cable, etc.). The wheel encoder 254, in communication with the control unit 58, may be configured to assist in determining one or more aspects of the drive wheel 30 based on a rotation of the measuring wheel 252 by the drive wheel 30. Examples of these aspects may include, but are not limited to, a number of rotations, a direction of rotation (e.g., clockwise or anti-clockwise), an angular position (or angle of rotation), and a rotation speed.

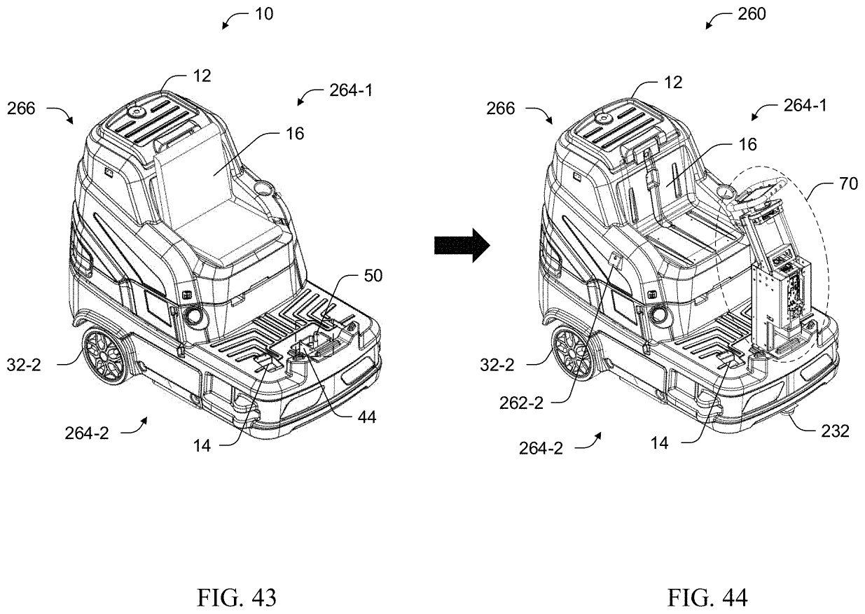

In one example, the typical scrubber 10 may be manipulated to retrofit the integrated steering column 70 and/or the retrofit kit 52 thereto. For instance, as illustrated in FIG. 43, the conventional steering assembly 18 may be removed from the typical scrubber 10 to expose the chassis bracket 44, and/or the drive shaft 50, for retrofitting the integrated steering column 70 thereto. In one embodiment (FIG. 44), the integrated steering column 70 may be mounted to the chassis bracket 44, and connected to the drive shaft 50, as discussed above. The integrated steering column 70 may be configured to turn the drive wheel 30, via the drive shaft 50, for steering the retrofitted scrubber 260. In one example, the integrated steering column 70 may include the box sensors mounted at a height of approximately 70 centimeters from the ground; however, some examples may include the box sensors being mounted at any height up to approximately 95 centimeters from the ground. Increase in the height may require in a downward tilt of the box sensors, so that any obstacles short in height or near the ground are also detected by the box sensors. Additionally, the electromechanical actuators 64, the remote sensor set 66-2, and the remote encoder set 68-2 may be mounted to the chassis 42, as discussed above, for transforming the non-autonomous typical scrubber 10 into the autonomous retrofitted scrubber 260. Hence, the retrofit kit 52 may be reliably assembled and retrofitted to the typical scrubber 10 without requiring any change to the existing structural design and re-configuration of the chassis 42 to provide the autonomous retrofitted scrubber 260, thereby preventing the complicated manufacturing process to shorten the time-to-market, reduce costs, and optimize convenience.

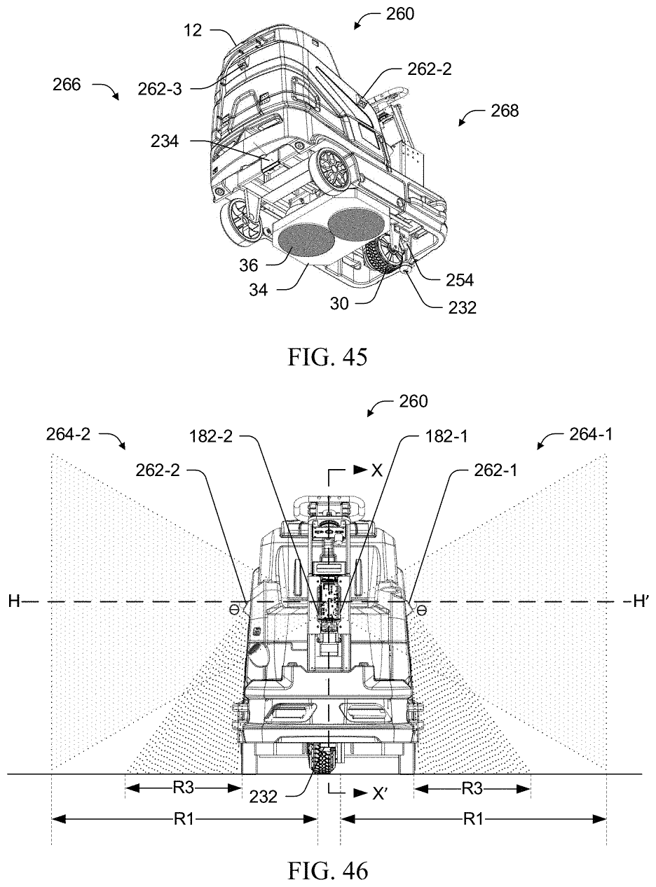

In one embodiment, the remote sensor set 66-2 (or the retrofit kit 52) may further include an auxiliary sensor set configured to scan the scrubber body 12 and ambient surfaces proximate thereto. The auxiliary sensor set may be configured for being retrofitted to the scrubber body 12. The auxiliary sensor set may include at least one proximity sensor having a 3D field of view such as a camera and a 3D LIDAR sensor. In one example, as illustrated in FIG. 44 and FIG. 45, the auxiliary sensor set may include a first ultrasonic sensor 262-1, a second ultrasonic sensor 262-2, and a third ultrasonic sensor 262-3 (hereinafter collectively referred to as auxiliary sensors 262). The first ultrasonic sensor 262-1 may be mounted to a first lateral side 264-1 of the scrubber body 12, as shown in FIG. 46. The second ultrasonic sensor 262-2 may be mounted to a second lateral side 264-2 of the scrubber body 12. The third ultrasonic sensor 262-3 may be mounted to a rear side 266 of the scrubber body 12. The auxiliary sensors 262 may be secured to the scrubber body 12 using suitable minimally-invasive fasteners (e.g., set screws, Velcro™, glue, etc.) and connection mechanisms (e.g., gluing, screw fit, etc.) known in the art, related art, or developed later. The auxiliary sensors 262 may be configured to eliminate or minimize any damage to the scrubber body 12 upon retrofitting. In one example, the auxiliary sensors 262 may be mounted at a height of approximately 80 cm from the ground; however, some examples may include the auxiliary sensors 262 being mounted at any height less than approximately 130 cm from the ground.

In one embodiment, each of the auxiliary sensors 262 may be oriented downwardly at a preset orientation angle with respect to a horizontal axis of the scrubber body 12 (or the retrofitted scrubber 260). In one example (FIG. 45), the auxiliary sensors 262 may be oriented at a downward orientation angle (θ) of approximately 40 degrees relative to the horizontal axis of the scrubber body 12 (or the retrofitted scrubber 260); however, other examples may include the orientation angle (θ) being any angle ranging from approximately 5 degrees to approximately 85 degrees depending on an extent of the field of view and range of the corresponding auxiliary sensor. Moreover, the orientation angle (θ) may be selected to have the corresponding field of views of the auxiliary sensors 262 cover a portion of the scrubber body 12 as well as the ground up to a maximum horizontal distance (R3) from the scrubber body 12 (or the retrofitted scrubber 260). In one example, the maximum horizontal distance (R3) may be approximately 0.5 meters; however, other examples may include any suitable maximum horizontal distance (R3) ranging from approximately 0.2 meters to approximately 1.5 meters depending on the field of view, the orientation angle, and/or the range of the corresponding auxiliary sensor. Each of the auxiliary sensors 262 may operate in communication with the control unit 58 in a wired or wireless manner. In some examples, the auxiliary sensors 262 may include wireless TOF sensors configured to communicate wirelessly with the control unit 58 or a remote device.

Similar to the auxiliary sensors 262, as illustrated in FIG. 46, the integrated steering column 70 may include the box sensors oriented away from each other. For example, the first lateral sensor 182-1 and the second lateral sensor 182-2 may be oriented towards a first direction and a second direction respectively. The first direction may be opposite to the second direction. For example, the first lateral sensor 182-1 may be oriented towards a first vertical plane comprising the first lateral side 264-1 of the retrofitted scrubber 260. The second lateral sensor 182-2 may be oriented towards a second vertical plane comprising the second lateral side 264-2 of the retrofitted scrubber 260. Each of the lateral sensors 182 may be located in the same horizontal plane H-H′ with the front sensor 184 located therebetween. However, in some examples, the lateral sensors 182 may be located in different horizontal planes. Each of the lateral sensors 182 and the front sensor 184 may have the first range (R1) greater than a third range (R3) of the auxiliary sensors 262.

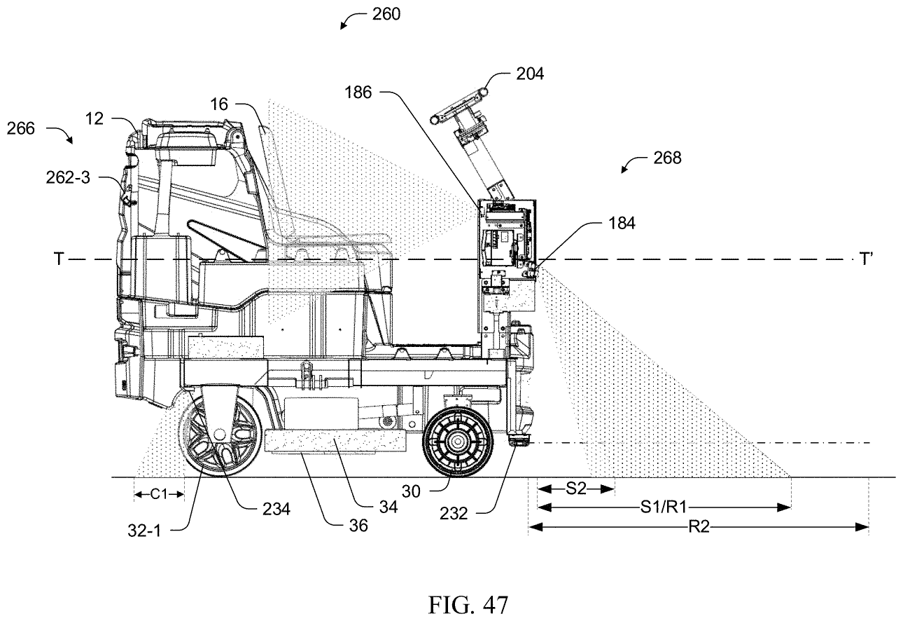

Further, as shown in FIG. 47, the front sensor 184 may be oriented towards a third vertical plane comprising a front side 268 of the retrofitted scrubber 260. The third vertical plane may be orthogonal to at least one of the first vertical plane and the second vertical plane. The front sensor 184 may be oriented at the predefined downward orientation angle, e.g., approximately 10 degrees relative to the longitudinal horizontal axis T-T′ of the chassis 42 (or the retrofitted scrubber 260), as discussed above. The front sensor 184 may be oriented to have a 3D field of view intersecting with the 2D field of view of the LIDAR sensor 232. However, some examples may include the front sensor 184 being oriented parallel to an orientation of the LIDAR sensor 232. For instance, the front sensor 184 may be oriented towards a third direction orthogonal to at least one of the first direction and the second direction. In some other instances, the front sensor 184 may be oriented to have a 3D field of view excluding the 2D field of view of the LIDAR sensor 232. The LIDAR sensor 232 may be oriented towards the third vertical plane comprising the front side 268 of the retrofitted scrubber 260. Opposite to the LIDAR sensor 232 and the front sensor 184, the integrated steering column 70 may include the presence sensor 186. For example, the presence sensor 186 may be oriented towards a fourth vertical plane comprising the rear side 266 of the retrofitted scrubber 260. The fourth vertical plane may be opposite to the third vertical plane. In some examples, the presence sensor 186 may be located in a horizontal plane excluding the box sensors. For instance, the presence sensor 186 may be located above a horizontal plane comprising at least the front sensor 184. The presence sensor 186 may be oriented towards a scrubber platform such as the seat 16. In one example, the presence sensor 186 may be oriented to have a 3D field of view scanning or covering a substantial portion of the seat 16. In some examples, the presence sensor 186 may oriented, upwardly or downwardly, at an angle relative to a horizontal axis of the chassis 42 or the retrofitted scrubber 260. The angle may range from zero degree to approximately 90 degrees. The presence sensor 186 may monitor a neutral state of the scrubber platform such as the seat 16. Further, the retrofitted scrubber 260 may include the cleaning sensor 234 mounted under the chassis 42. The cleaning sensor 234 may be oriented downwardly at a predefined sensor angle (e.g., approximately 45 degrees) relative to a vertical axis (or horizontal axis) of the chassis 42 or the retrofitted scrubber 260. As shown, in one example, the cleaning sensor 234 may be oriented to have the 3D field of view and a range C1. For instance, the cleaning sensor 234 may be oriented to have the 3D field of view covering a portion of at least one of the non-drive wheels 32 (i.e., rear wheels or non-motorized wheels) such as the non-drive wheel 32-1. Additionally, in one example, the 3D field of view of the cleaning sensor 234 may also include a floor surface.

### Example Operation

During operation, in one embodiment, an operator may provide an ignition input to the control unit 58, via the interactive display unit 206 or a traditional key turned in an ignition switch, for starting the retrofitted scrubber 260. In response to the ignition input, the control unit 58 may trigger the onboard controller 38, which may cause the onboard power source 8 (e.g., battery or internal combustion engine) to supply power for driving the retrofitted scrubber 260. Alternatively, in some examples, the control unit 58 may be configured to directly control the onboard power source 8 for powering the retrofitted scrubber 260. Further, in one embodiment, the control unit 58 may be configured to operate the retrofitted scrubber 260 in one or more modes, e.g., a non-autonomous mode, a training mode, and/or an autonomous mode (hereinafter collectively referred to as device modes). In one example, the device modes may be selected by the operator via a software interface (or dashboard) of the interactive display unit 206. In some examples, the device modes may be activated using a remote device operating in communication with the control unit 58. Other examples may include the control unit 58 being configured to activate (or deactivate) any of the device modes based on predefined conditions. For instance, the control unit 58 may be configured to activate (or deactivate) a preset device mode based on at least one of (i) a predefined or dynamically defined clock time, (ii) a predefined or dynamically defined duration elapsed since a clock time of the last use (or shut down) of the retrofitted scrubber 260, and (iii) a predefined or dynamically defined duration elapsed since a clock time of the last activation (or deactivation) of that preset device mode, or any combinations thereof.

### Example Non-Autonomous Mode

In one embodiment, the control unit 58 may activate the non-autonomous mode for the retrofitted scrubber 260. In the non-autonomous mode, the control unit 58 may operate in response to operator inputs for controlling various functions of the retrofitted scrubber 260. For instance, the control unit 58 may receive the operator inputs via the integrated steering column 70 using a by-wire system. In one example, the integrated steering column 70 may include the interactive display unit 206 having a software interface configured to receive one or more inputs from the operator electronically. The received operator inputs may act as a trigger for the control unit 58 to perform preset or dynamically set tasks or functions. However, in some examples, the integrated steering column 70 may be installed with hardware interfaces, for example, physical buttons, joysticks, switches, knobs, pedals, microphones (e.g., to enable voice-based control), etc., for providing triggers to the control unit 58 and performing the preset or dynamically set tasks or functions. For instance, the operator may manipulate the foot pedal 14 to move the retrofitted scrubber 260.

The foot pedal 14 may assist in managing a moving speed of the retrofitted scrubber 260. In one example, the foot pedal 14 may be configured as a dedicated brake pedal. The foot pedal 14 may be pushed by the operator for providing a trigger to the control unit 58. In another example, the control unit 58 may receive the trigger when the operator may take off the foot from the foot pedal 14, which may be configured as an accelerator pedal. In response to the trigger, the control unit 58 may drive the brake assembly to apply the brakes to the drive wheel 30. The applied brakes may impede the speed of rotation, or stop the rotation, of the drive wheel 30 to control a speed of motion of the retrofitted scrubber 260. On the other hand, in the absence of the trigger, the control unit 58 may maintain, or increase, the speed of rotation of the drive wheel 30 based on the power received via the transmission system to drive the retrofitted scrubber 260.

While driving, the operator may manipulate the steering handle 204 to steer the retrofitted scrubber 260. For instance, the operator may rotate the steering handle 204 clockwise or anti-clockwise to steer the retrofitted scrubber 260. The rotation of the steering handle 204, via the base shaft, may be monitored by the steering encoder 220 in communication with the control unit 58. In one example, the steering encoder 220 may generate a first steering signal based on a clockwise rotation of the steering handle 204, and a second steering signal based on an anti-clockwise rotation of the steering handle 204. Each of the first steering signal and the second steering signal (hereinafter collectively referred to as steering signals) may indicate a direction of rotation of the steering handle 204 to the control unit 58. The steering signals may be received by the control unit 58 for driving the gearbox shaft 94 in the motor sub-assembly 86 of the integrated steering column 70. In one example, the control unit 58 may trigger the electric motor 102 in the motor gearbox unit 92 based on the received steering signals. The triggered electric motor 102 may provide a torque to rotate the gearbox shaft 94. For instance, the electric motor 102 may provide a torque to rotate the gearbox shaft 94 (i) clockwise based on the first steering signal and (ii) anti-clockwise based on the second steering signal.

The clockwise and anticlockwise rotations of the gearbox shaft 94 may be monitored by the control unit 58 using the motor encoder 96. Similar to the steering encoder 220, the motor encoder 96 may be configured to generate signals depending on rotations of the gearbox shaft 94. For example, the motor encoder 96 may generate a first motor signal based on the clockwise rotation of the gearbox shaft 94. Similarly, the motor encoder 96 may generate a second motor signal based on the anti-clockwise rotation of the gearbox shaft 94. Each of the first motor signal and the second motor signal (hereinafter collectively referred to as motor signals) may be indicative of a direction of rotation of the gearbox shaft 94 to the control unit 58. The rotating gearbox shaft 94 may, in turn, provide a torque to rotate the drive shaft 50 connected to the drive wheel 30, e.g., front wheel. The drive shaft 50 and the gearbox shaft 94 may rotate in the same direction due to the physical coupling therebetween via the coupler 88, as discussed above. For instance, the drive shaft 50 may rotate clockwise based on the clockwise rotation of the gearbox shaft 94. Similarly, the drive shaft 50 may rotate anti-clockwise based on the anti-clockwise rotation of the gearbox shaft 94.

The clockwise rotation of the drive shaft 50 may turn (or steer) the drive wheel 30 rightward about a vertical axis of the drive shaft 50 (or the tail shaft 134 of the gearbox shaft 94). In some examples, the vertical axis may pass through a center of the drive wheel 30 (or the integrated steering column 70). Depending on a degree of rightward rotation of the drive wheel 30, the retrofitted scrubber 260 may gradually turn (or steer) towards the right while being in motion. Similarly, the anti-clockwise rotation of the drive shaft 50 may turn (or steer) the drive wheel 30 leftward relative to the vertical axis of the drive shaft 50 (or the tail shaft 134 of the gearbox shaft 94). Based on a degree of leftward rotation of the drive wheel 30, the retrofitted scrubber 260 may gradually turn (or steer) towards the left during motion. Hence, the drive shaft 50 may turn the drive wheel 30 about the vertical axis based on a rotation of the gearbox shaft 94 for steering the retrofitted scrubber 260.

In addition to the gearbox shaft 94, the control unit 58 may monitor a wheel spin of the drive wheel 30 via the wheel encoder 254. As the operator may drive the retrofitted scrubber 260, in one example, the wheel encoder 254 may generate a first wheel signal based on a forward spin of the drive wheel 30, and a second wheel signal based on a reverse spin of the drive wheel 30. Each of the first wheel signal and the second wheel signal (hereinafter collectively referred to as wheel signals) may be received by the control unit 58. The wheel signals may assist the control unit 58 in detecting a forward motion and a backward motion of the retrofitted scrubber 260 based on the directions of the wheel spin (i.e., the forward spin and the reverse spin respectively) of the drive wheel 30. To control or stop the wheel spin, the operator may manipulate the foot pedal 14 of the retrofitted scrubber 260, as discussed above.

While navigating the retrofitted scrubber 260, in one example, the operator may also provide an input, e.g., via the interactive display unit 206, to the control unit 58 for manipulating the scrubber assembly to clean the floor. In one embodiment, the scrubber assembly may include the brush unit 34; however, other embodiments may include the scrubber assembly additionally, or alternatively, including a vacuum unit (not shown). The scrubber assembly may be manipulated via the scrubber actuator 74 to clean a surface such as the floor. For instance, the control unit 58 may generate a first scrubber signal to drive the scrubber actuator 74 in response to the operator input. The scrubber actuator 74 may drive the brush unit 34 based on the first scrubber signal to lower the brush unit 34 for engaging the brushes 36 with the floor to be cleaned. In some examples, the brush unit 34 may include rotatory brushes. The control unit 58, in some examples, also activate a rotation of the rotatory brushes based on the first scrubber signal while lowering the brush unit 34 to engage the rotatory brushes with the floor. Similarly, the operator may provide another input to the control unit 58 via the interactive display unit 206 to stop an operation, e.g., of the brush unit 34 in the scrubber assembly. In one example, the control unit 58 may generate a second scrubber signal based on such another operator input to drive the scrubber actuator 74 for manipulating the brush unit 34. The scrubber actuator 74 may drive the brush unit 34 based on the second scrubber signal to raise the brush unit 34 upwards to disengage the brushes 36 from the floor. In some examples where the brush unit 34 may include the rotatory brushes, the control unit 58 may also deactivate the rotation of the rotatory brushes based on the second scrubber signal while disengaging the brushes 36 from the floor.

Further, during the non-autonomous mode, the control unit 58 may deactivate the retrofitted local sensor set 66-1 and/or the retrofitted remote sensor set 66-2 (hereinafter collectively referred to as sensor system). However, in some examples, the operator may provide inputs to the control unit 58 via the interactive display unit 206 to (i) activate the sensor system for scanning (1) a surrounding environment and (2) at least a portion of the body of the retrofitted scrubber 260, and (ii) provide an indication based on the sensor system detecting (1) obstacles and/or (2) contamination on a surface such as an unclean floor and a wheel surface to assist the operator in appropriately performing the cleaning task while driving the retrofitted scrubber 260. In some examples, the indication may be sent to the interactive display unit 206 or a remote computing device. Examples of the indication may include, but are not limited to, numeric indications, alphanumeric indications, or non-alphanumeric indications such as vibrations, sounds, colors, luminance, patterns, textures, and graphical objects, perceivable through tangible indicators (e.g., light emitting diodes, vibrators, speakers, display device, etc.) or displayable on software interface(s), such as a dashboard on the interactive display unit 206, or any other suitable types of audio, visual, textual, and haptic indications known in the art, related art, or developed later.

### Example Training Mode

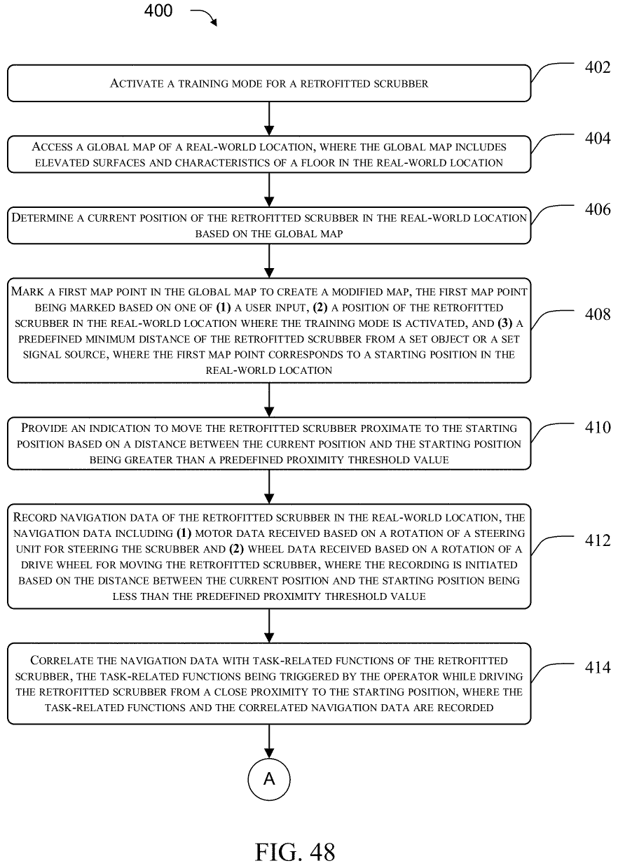

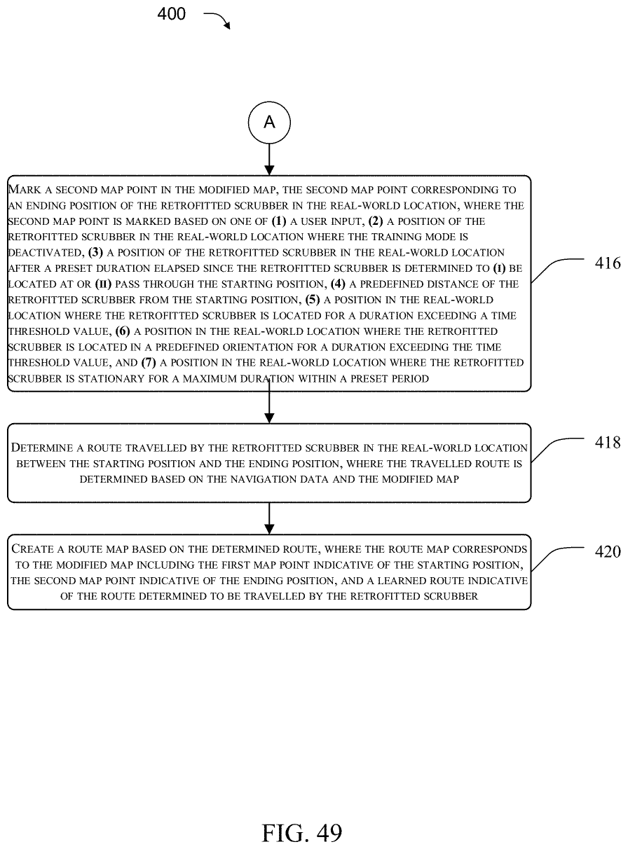

FIGS. 48-49 illustrate an exemplary method 400 of recording an exemplary route and an exemplary function of the retrofitted autoscrubber of FIG. 47, according to an embodiment of the present application. In one embodiment, the control unit 58 may execute the exemplary method 400 of FIGS. 48-49. The order in which the method 400 is described here is not intended to be construed as a limitation, and any number of the described method steps may be combined, deleted, or otherwise performed in any order to implement these or an alternate set of instructions without departing from the concepts, embodiments, and any variants thereof, described in the present application. The exemplary instructions may be described in the general context of computer-readable instructions, which may be stored on a computer-readable medium, and installed or embedded in an appropriate device for execution. Further, the instructions may be implemented in any suitable hardware, software, firmware, or combination thereof, that exists in the related art or that is later developed.

At step 402, the control unit 58 may activate the training mode for the retrofitted scrubber 260 based on an operator input or predefined conditions such as those mentioned above. During the training mode, the control unit 58 may be configured to record a route travelled by the retrofitted scrubber 260. The control unit 58 may be further configured to record a predefined or dynamically defined function performed by the retrofitted scrubber 260. In some examples, the control unit 58 may record such function while the retrofitted scrubber 260 is in motion. In one embodiment, the operator may “teach” the route to the control unit 58 by manually driving the retrofitted scrubber 260, as discussed above. The control unit 58 may be configured to record the functions, and/or related aspects of components, of the retrofitted scrubber 260 during the training mode.

At step 404, a global map of a location may be accessed. In one embodiment, the control unit 58 may access a global map of a real-world location. The global map may represent a virtual map (e.g., digital map) of an environment of the real-world location, or a sub-location therein. In some examples, the global map may correspond to a real-world location where the retrofitted scrubber 260 may be located. The global map may be a 2D map or a 3D map of the location. The global map may include a set of features (e.g., static features) indicative of physical objects, partitions, and boundary/perimeter including entry and exit points in the real-world location. These location features may be static or fixed with respect to time in one example. In some examples, the global map may also include elevated surfaces (e.g., walls, partitions, objects, etc.) and characteristics of a floor at the location. Examples of the floor characteristics may include, but are not limited to, a floor elevation or incline, a floor depression or decline, a floor layout, and floor terrain type. In one example, the global map may be generated using any suitable simultaneous localization and mapping (SLAM) methodologies known in the art including, but not limited to, Gmapping based on Rao-Blackwellized particle filtering using sensor data from the sensor system. The global map may be stored locally in a data storage device on the retrofitted scrubber 260. Other examples may include the global map being stored on a portable computer-readable medium or a remote computing device accessible by the control unit 58.

At step 406, a current position in the real-world location is determined. In one embodiment, the control unit 58 may determine a current position of the retrofitted scrubber 260 based on the global map of the real-world location where the retrofitted scrubber 260 may be located. The control unit 58 may scan the environment via the sensor system (e.g., LIDAR sensor 232, box sensors, auxiliary sensors 262, etc.) to recognize various landmarks and other physical attributes in the environment. The control unit 58 may then compare these attributes with those in the global map to localize the retrofitted scrubber 260. Localization is the process by which the control unit 58 may determine the current position, orientation, and a rate of change of the retrofitted scrubber 260 within the global map (e.g., static map). Different procedures known in the art may be used by the control unit 58 to localize the retrofitted scrubber 260. In one example, the control unit 58 may localize the retrofitted scrubber 260 using any suitable methods known in the art such as dead reckoning methodology to obtain an estimate of a change in position of the retrofitted scrubber 260 using odometry and inertial navigation systems.

At step 408, a first map point indicative of a starting position is marked in the global map. In one embodiment, the control unit 58 may record or mark a first map point in the global map based on an operator input. For instance, the operator may access the global map, e.g., on the interactive display unit 206 or a remote device. In the global map, the operator may mark, via the control unit 58, a first map point (i.e., virtual checkpoint) to create a modified map. The marked first map point may correspond to a starting position in the real-world location. In some examples, the control unit 58 may be configured to set the first map point based on an activation of the training mode. For instance, the control unit 58 may mark the first map point corresponding to a current position of the retrofitted scrubber 260 where the training mode may be activated, thereby recording such current position of the retrofitted scrubber 260 as the starting position.

In another embodiment, the control unit 58 may mark the first map point to record or define the starting position based on a predefined proximity distance of the retrofitted scrubber 260 from a set object or a set signal source. For example, the control unit 58 may calculate distance values to nearby objects/surfaces based on sensor data received from the sensor system (e.g., auxiliary sensors 262) and compare the calculated distance values with a preset proximity threshold value (e.g., approximately 1 meter, approximately 2 meters, approximately 5 meters, etc.). In one example, if the calculated distance values may be less than the preset proximity threshold value, the control unit 58 may record the corresponding position of the retrofitted scrubber 260 as the starting position in the real-world location and put a corresponding first map point in the global map. In some examples, all the calculated distance values (e.g., based on the auxiliary sensors 262) being less than the preset proximity threshold value may indicate a preset parking spot (e.g., a three-wall shed, a fenced platform, etc.) for the retrofitted scrubber 260.

In another example, the control unit 58 may record a position of the retrofitted scrubber 260 as the starting position based on a proximity to a signal source being less than the preset proximity threshold value. The signal source may include any object, including a computing device or a network device, configurable for providing a signal compatible with the control unit 58, or the telemetry circuit connected thereto. Examples of the signal may include, but are not limited to, radiofrequency signals such as Wi-Fi signals and Bluetooth signals, acoustic signals, and light signals. The control unit 58 may determine the proximity/distance (e.g., Euclidean distance, etc.) to the signal source based on a strength of the signal received from the signal source in one example; however, any other suitable techniques known in the art may also be contemplated. Based on recording of the starting position, the control unit 58 may mark a corresponding first map point in the global map to create the modified map. The starting position may be a set position or space on the floor; however, some examples may include the starting position being an elevated surface or elevated platform.

At step 410, an indication may be provided for the operator. In one embodiment, the control unit 58 may provide an indication for the operator when the retrofitted scrubber 260 may be far from the recorded starting position. For example, the control unit 58 may calculate (or estimate) a start distance between the current position of the retrofitted scrubber 260 and the recorded starting position. The start distance may be calculated using any suitable techniques known in the art including, but are not limited to, K-means clustering, time-of-flight measurements, and phase shift measurements. If the calculated (or estimated) start distance may be greater than a predefined proximity threshold value (e.g., greater than approximately 1 meter, greater than approximately 2 meters, greater than approximately 5 meters, etc.), the control unit 58 may provide the indication, such as those mentioned above, for the operator. In some examples, the indication may encourage the operator to drive the retrofitted scrubber 260 to the starting position.

At step 412, navigation data of the retrofitted scrubber 260 may be recorded. In one embodiment, the control unit 58 may record navigation data of the retrofitted scrubber 260 based on the operator driving the retrofitted scrubber 260. For example, the control unit 58 may be configured to calculate and record the degree of rotations of the gearbox shaft 94, and hence, that of the drive shaft 50, in both clockwise and anti-clockwise directions based on the received motor signals. The control unit 58 may also record durations of these rotations of the gearbox shaft 94. In one example, the control unit 58 may calculate an angle of rotation (or degree of rotation) of the gearbox shaft 94, and hence that the drive shaft 50, using Equation 1; however, other calculation methods and formulas may also be contemplated depending on the type of retrofitted encoders including the motor encoder 96 implemented on the retrofitted scrubber 260. The calculated degree of rotations, both clockwise and anti-clockwise, along with the respective durations of rotations related thereto (hereinafter collectively referred to as the motor data) may be stored in the local data storage device, or in some examples, on a remote device by the control unit 58 for future access and/or retrieval.

$$Angle of Rotation ( Degrees ) = \frac{c}{C P R} \times 360 \qquad ( 1 )$$

where:
C=No. of counts (or no. of pulses) received from an encoder
CPR=Total number of possible counts per revolution (or pulses per revolution) of a shaft Angle of Rotation (or Degree of Rotation) in degrees

In one example, the control unit 58 may record the degree of rotation as (i) positive based on a clockwise rotation of the gearbox shaft 94, (ii) negative based on an anti-clockwise rotation of the gearbox shaft 94, and (iii) zero based on no rotation of the gearbox shaft 94. The degree of rotation in each of the clockwise and anti-clockwise directions (hereinafter collectively referred to as rotation directions) may range from 0 degree to approximately 55 degrees based on the corresponding rotation directions of the steering handle 204. However, some examples may include the degree of rotation in each of the rotation directions up to approximately 90 degrees. In other examples, the degree of rotation being any value from zero to approximately 5 degrees may be indicative of the steering handle 204 in the neutral position.

Further, the control unit 58 may also calculate and record a number and/or speed of rotations of the drive wheel 30 based on the wheel signals. For example, the control unit 58 may measure a number of forward rotations (and/or a speed of forward rotation) of the drive wheel 30 based on the first wheel signal and a number of backward rotations (and/or a speed of backward rotation) of the drive wheel 30 based on the second wheel signal. Each of the number of forward rotations (and/or speed of forward rotation) and/or the number of backward rotations (and/or speed of backward rotation) (hereinafter collectively referred to as wheel data) may be stored in the local data storage device or, in some examples, on a remote device, by the control unit 58 for future access and/or retrieval.

The control unit 58 may initiate recording the wheel data and the motor data, hereinafter collectively referred to as the navigation data, based on the retrofitted scrubber 260 being proximate to the starting position. For example, the control unit 58 may determine the current position of the retrofitted scrubber 260, as discussed above. If a distance between the current position and the starting position, is less than the predefined proximity threshold value, the control unit 58 may begin to record and store the navigation data, as discussed above. In some examples, the control unit 58 may begin to record the navigation data after the retrofitted scrubber 260 is determined to (i) be located at, or (ii) pass through the starting position.

At step 414, navigation data is correlated with task-related functions of the retrofitted scrubber 260. In one embodiment, the operator may trigger a task-related function of the retrofitted scrubber 260 while driving the retrofitted scrubber 260 in the location to perform a preset task such as a cleaning of a surface such as the floor. Examples of the task-related functions may include, but are not limited to, activating, or deactivating, the scrubber assembly, or any components thereof. For instance, the operator may provide an input or trigger to the control unit 58 for manipulating the scrubber assembly. Based on the operator input, the control unit 58 may generate the first scrubber signal to actuate the scrubber actuator 74 for driving, e.g., the brush unit 34 in one example; however, other examples may include the scrubber actuator 74 driving the vacuum unit in the scrubber assembly. The brush unit 34 may in turn actuate the brushes 36 to engage with a surface such as the floor to be cleaned, as discussed above. In one example, the control unit 58 may record a position of the retrofitted scrubber 260 (i.e., first scrubber position) at which the first scrubber signal may be generated. The control unit 58 may also record a duration (i.e., brush duration) for which the brushes 36 may be engaged with the floor. While the operator may be driving the retrofitted scrubber 260, the control unit 58 may correlate the first scrubber position and the brush duration with real-world positions and respective navigation data of the retrofitted scrubber 260. Similarly, the control unit 58 may generate the second scrubber signal based on an operator input to manipulate the scrubber actuator 74 to disengage the brushes 36 from the floor, as discussed above. In one example, the control unit 58 may also record a position of the retrofitted scrubber 260 (i.e., second scrubber position) at which the second scrubber signal may be generated. The control unit 58 may also record a duration (i.e., unbrush duration) for which the brushes 36 may be disengaged from the floor. While the retrofitted scrubber 260 may be driven, or made stationary, by the operator, the control unit 58 may correlate both the second scrubber position and the unbrush duration with real-world positions and respective navigation data of the retrofitted scrubber 260. Each of the first scrubber position and the second scrubber position (hereinafter collectively referred to as scrubber positions) may be real-world positions of the retrofitted scrubber 260 in the operating location. Each of the scrubber positions, the brush duration, and the unbrush duration (hereinafter collectively referred to as cleaning data) as well as the correlated navigation data may be stored in the local data storage device, or in some examples, on a remote device by the control unit 58 for future access and/or retrieval.

At step 416, a second map point is marked in the modified map. In a first embodiment, the control unit 58 may record or mark a second map point in the modified map based on an operator input. For instance, the operator may access the modified map, e.g., on the interactive display unit 206 or a remote device. In the modified map, the operator may mark, via the control unit 58, the second map point (i.e., virtual checkpoint) that may correspond to an intended ending position for the retrofitted scrubber 260 in the real-world location.

In a second embodiment, the control unit 58 may mark the second map point in the modified map based on deactivation of the training mode. For instance, the control unit 58 may mark the second map point in the modified map, where the second map point may correspond to a current position of the retrofitted scrubber 260 where the training mode may be deactivated, thereby recording such current position of retrofitted scrubber 260 as the ending position. In some examples, similar to the starting position, the control unit 58 may also record the ending position based on calculated distance values to a set object or a set signal source being less than preset proximity threshold value, as discussed above.

In a third embodiment, the control unit 58 may record the second map point (or the ending position) with respect to the first map point (or the starting position). For instance, the control unit 58 may set the second map point in the modified map (or record the corresponding ending position) based on the navigating retrofitted scrubber 260 determined to be located at a predefined proximity distance from the first map point (or the corresponding starting position), or vice versa. In one example, the predefined proximity distance may have any value ranging from approximately 1 meter to approximately 50 meters, such as 1 meter, 2 meters, 5 meters, and 10 meters. However, some examples may include the value of the predefined proximity distance in excess of 50 meters depending on the size of the real-world location where the retrofitted scrubber 260 may be operating or located. Other examples may include the second map point (or the ending position) being marked or recorded same as the first map point (or the starting position).

In a fourth embodiment, the control unit 58 may mark the second map point in the modified map based on a current position of the retrofitted scrubber 260 after a preset duration elapsed since being proximate to the first map point (or the starting position). In some examples, the control unit 58 may consider the retrofitted scrubber 260 being proximate to the first map point when the retrofitted scrubber 260 may (i) be located at or (ii) pass through the starting position.

In a fifth embodiment, the control unit 58 may mark the second map point in the modified map based on a position in the real-world location where the retrofitted scrubber may be located for a hold duration exceeding a time threshold value. The retrofitted scrubber 260 may be stationary at the position for the hold duration. The control unit 58 may record this position as the ending position, which may correspond to the second map point in the modified map. In some examples, the control unit 58 may record the ending position (or mark the second map point) based on the retrofitted scrubber 260 located in a predefined orientation at the position for the hold duration. In further examples, the control unit 58 may record the ending position (or mark the second map point in the modified map) based on the retrofitted scrubber 260 being stationary at a position for a maximum duration within a preset period. Each of the time threshold value and the maximum duration may be greater than approximately 2 minutes up to approximately 30 minutes in some instances. The preset period may correspond to a duration between different clock times. For instance, the preset period may correspond to a set schedule (e.g., cleaning schedule, work shift schedule, etc.) such as 9:00 am to 5:00 pm. Other instances may include the preset period ranging from approximately 30 minutes to approximately 8 hours.

In some examples, each of the starting position and the ending position (collectively referred to as operative positions) may be recorded at different time intervals or clock times. For instance, the control unit 58 may be configured to record the starting position (or mark the corresponding first map point) and record the ending position (or mark the corresponding second map point) at different time intervals (or clock times) while the retrofitted scrubber 260 may be moving to avoid an overlap between the operative positions.

At step 418, a route travelled by the retrofitted scrubber is determined. In one embodiment, the control unit 58 may record a route travelled by the retrofitted scrubber 260 from the starting position to the ending position. The travelled route may be determined by the control unit 58 based on the navigation data and the modified map. For example, the control unit 58 may be configured to record the travelled route (hereinafter referred to as learned route) using the sensor system. The control unit 58 may track a current position of the retrofitted scrubber 260 based on odometry data and/or sensor data thereof, as discussed above. The odometry data may include, but is not limited to, the navigation data including the wheel data and the motor data, as discussed above. In some examples, the odometry data may further include information received from, or calculated by the control unit 58 based on inputs from any other odometry sensors that may be retrofitted or preinstalled on the retrofitted scrubber 260. Examples of these odometry sensors may include, but are not limited to, the steering encoder 220, the accelerometer, the odometer, the gyroscope, the magnetometer, the inertial measurement unit (IMU), and the speedometer. On the other hand, the sensor data may include, but is not limited to, data received or calculated by the control unit 58. In one example, the sensor data may include data obtained using the retrofitted sensors such as LIDAR sensor 232, the box sensors, the auxiliary sensors 262, the cleaning sensor 234, or any combinations thereof. Other examples may subsume the sensor data including data obtained using any other sensors preinstalled on the retrofitted scrubber 260.

In some examples, the control unit 58 may create local maps (i.e., dynamic maps) based on spatial movement of the retrofitted scrubber 260 between the operative positions. The control unit 58 may create the local maps based on the sensor data, independently or in combination with the odometry data, using any suitable technologies known in the art including, but not limited to, SLAM methodologies. The local maps may be compared or aligned, either individually or collectively, with the modified map (or the global map) by the control unit 58 to determine a current position of the retrofitted scrubber 260 and the corresponding travelled route. In some examples, the control unit 58 may determine and record the travelled route (i.e., learned route) relative to the surroundings, including elevated surfaces (e.g., walls, partitions, objects, etc.) and characteristics of the floor surface (e.g., floor elevation/incline, floor decline, floor layout, floor terrain, etc.) sensed by the sensor system.

At step 420, a route map is created based on the determined route (or learned route). In one embodiment, as the retrofitted scrubber 260 may be moved or driven by the operator, the control unit 58 may mark the learned route in the modified map (or the global map) based on changing positions of the retrofitted scrubber 260 between the operative positions, thereby updating the modified map (or the global map) to create a route map. In some examples, the route map may be a new map separate or different from the modified map (or global map). The route map may include the first map point indicative of the predetermined starting position, the second map point indicative of the predetermined ending position, the learned route travelled by the retrofitted scrubber 260. In some examples, the route map may also include a set of features (e.g., static features) indicative of physical objects, partitions, and boundary/perimeter including entry and exit points in the real-world location accessed by the retrofitted scrubber 260. In some other examples, the route map may also include elevated surfaces (e.g., walls, partitions, objects, etc.) and characteristics of the floor (e.g., floor elevation/incline, floor decline, floor layout, floor terrain, etc.) at the location. The route map may be a 2D map or a 3D map.

In further examples, separate route maps may be created based on the operative positions. For instance, the control unit 58 may create a first route map for a route travelled from the starting position to the ending position by the retrofitted scrubber 260. Similarly, the control unit 58 may create a second route map for a route travelled from the ending position to the starting position by the retrofitted scrubber 260. The first route map may be different from second route map, in some instances, depending on (i) a route followed or travelled and (ii) obstacles encountered by the retrofitted scrubber 260 between the operative positions. The route map may be stored in the local data storage device, or a remote device, by the control unit 58 for future access and/or retrieval.

### Example Autonomous Mode

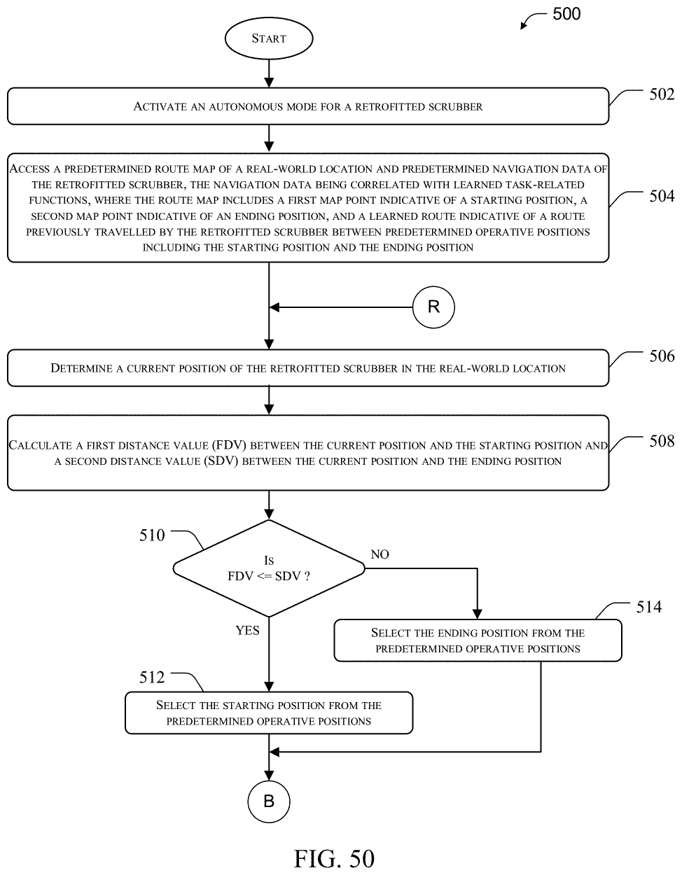

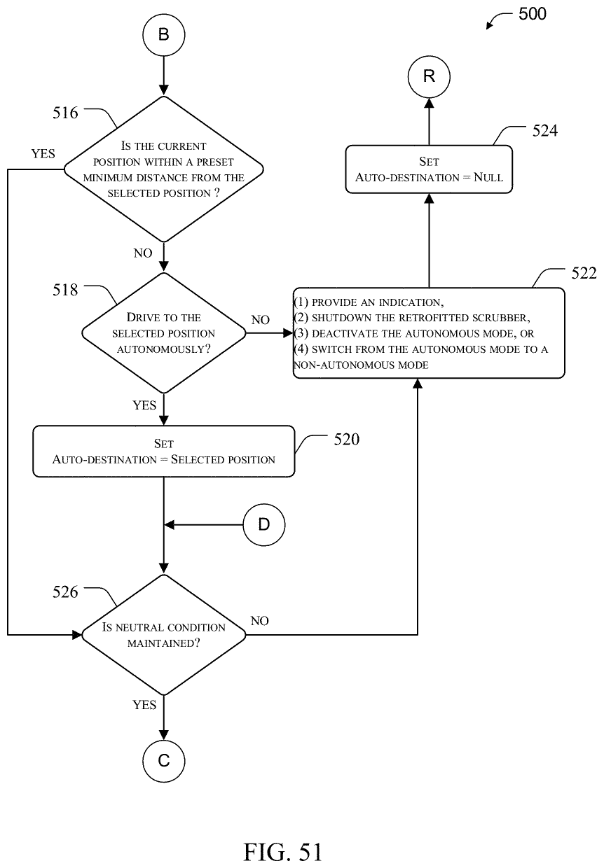

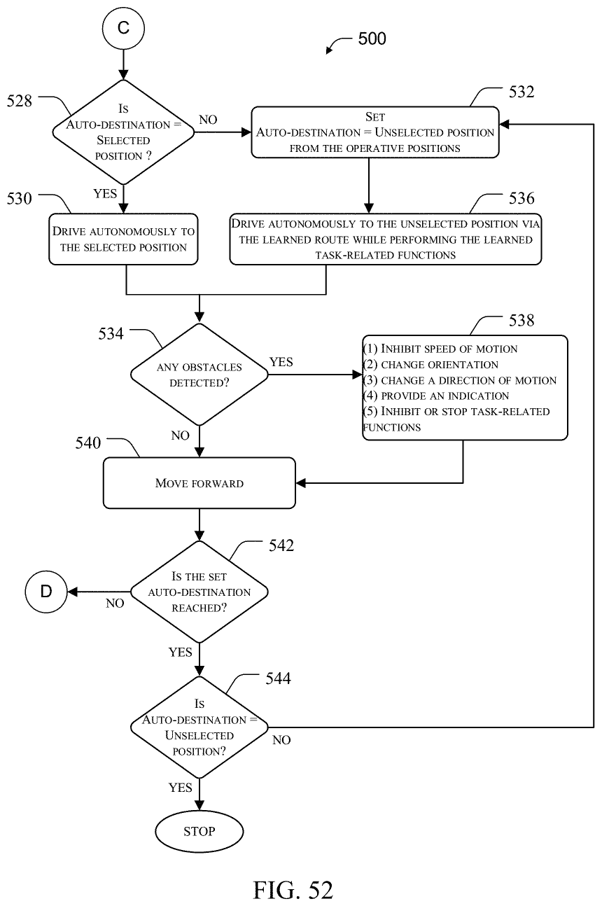

FIGS. 50-52 illustrate an exemplary method 500 of autonomously driving the retrofitted autoscrubber of FIG. 47, according to an embodiment of the present application. In one embodiment, the control unit 58 may execute an exemplary method 500 of FIGS. 50-52. The order in which the method 500 is described here is not intended to be construed as a limitation, and any number of the described method steps may be combined, deleted, or otherwise performed in any order to implement these or an alternate set of instructions without departing from the concepts, embodiments, and any variants thereof, described in the present application. The exemplary instructions may be described in the general context of computer-readable instructions, which may be stored on a computer-readable medium, and installed or embedded in an appropriate device for execution. Further, the instructions may be implemented in any suitable hardware, software, firmware, or combination thereof, that exists in the related art or that is later developed.

At step 502, an autonomous mode may be activated. In one embodiment, the operator may select and activate the autonomous mode via a dashboard in (i) the interactive display unit 206 or (ii) a remote computing device. However, some examples may include the control unit 58 configured to switch from the non-autonomous mode (or the training mode) to the autonomous mode based on a set condition. For example, the control unit 58 may be configured to select and activate the autonomous mode based on rotations of the steering handle 204 in a predefined sequence or order within a preset period. One example of such rotation sequence may include (a) first rotating the steering handle 204 clockwise to a full extent of possible rotation (E1), e.g., total (+) 55 degrees, from the neutral position, (b) then rotating the steering handle 204 anticlockwise to a full extent of possible rotation (E2) from E1, e.g., total negative (−) 110 degrees, and (c) followed by a return of the steering handle 204 from E2 to the neutral position, e.g., total (+) 55 degrees, while performing all steps (a), (b), and (c) in less than approximately 20 seconds. Any other suitable rotation sequence or combinations for the steering handle 204 for switching to or activating the autonomous mode may also be contemplated. In a further example, the control unit 58 may activate the autonomous mode based on at least one of (i) a predefined or dynamically defined clock time, (ii) a predefined or dynamically defined duration elapsed since a clock time of the last use (or shut down) of the retrofitted scrubber 260, and (iii) a predefined or dynamically defined duration elapsed since a clock time of the last activation (or deactivation) of the autonomous mode, or any combinations thereof.

In the autonomous mode, the control unit 58 may be configured to, at least one of, (1) obtain or access the predefined or stored route map (or the modified map), (2) determine the predefined starting position, the predefined ending position, and the learned route therebetween based on the route map (and the global map or the modified map), (3) autonomously drive the retrofitted scrubber 260 along the learned route from the starting position to the ending location, or vice versa, (4) autonomously drive the scrubber actuator 74 to manipulate a component of the scrubber assembly, e.g., the brush unit 34 for deploying the brushes 36 in contact with the floor surface, or away therefrom, based on a level of contamination (i.e., dirt, debris, spillage, etc.) on the floor surface (or on a wheel of the retrofitted scrubber 260), and (5) deactivate the autonomous mode based on (i) a change in a neutral condition of the retrofitted scrubber 260 or (ii) the retrofitted scrubber 260 reaching one of the predefined operative positions after starting the autonomous navigation.

At step 504, a predetermined route map and predetermined navigation data of the retrofitted scrubber 260 may be accessed. In one embodiment, the control unit 58 may access the stored route map and the stored navigation data of the retrofitted scrubber 260. The route map may be stored in a local data storage, or in some examples, on a remote device. The route map may represent a map of a real-world location, such as a room, where the retrofitted scrubber 260 may require to operate autonomously. The accessed route map may include the predefined first map point indicative of the predetermined starting position and the predefined second map point indicative of the predetermined ending position. Each of the starting position and the ending position (collectively, operative positions) may correspond to positions in the real-world location, such as the room, where the retrofitted scrubber 260 may require to operate autonomously. The accessed route map may also include the learned route previously travelled by the retrofitted scrubber 260 between the operative positions in that room. In some examples, the control unit 58 may also access the modified map (or the global map) of the same room. The control unit 58 may determine the predetermined starting position, the predetermined ending position, and the learned route therebetween based on the route map (and the global map or the modified map),

At step 506, a current position of the retrofitted scrubber 260 is determined. In one embodiment, in the autonomous mode, the control unit 58 may determine a current position of the retrofitted scrubber 260 in the room based on the route map using any suitable techniques known in the art including those related to SLAM-based algorithms, as discussed above. For instance, the control unit 58 may determine the current position based on a comparison between the accessed route map (or the corresponding global map) and local maps (or dynamic maps) created using the sensor system (e.g., LIDAR sensor 232, box sensors, auxiliary sensors 262, etc.). In some examples, the control unit 58 may also use data from the odometry and inertial navigation systems to determine the current position of the retrofitted scrubber 260 in the location.

At step 508, a distance value from the current position of the retrofitted scrubber to each of the operative positions is calculated. In one embodiment, the control unit 58 may calculate values of distances (or estimate distances) between the current position of the retrofitted scrubber 260 and each of the operative positions. For example, the control unit 58 may calculate (or estimate) a first distance value (FDV) between the current position and the predefined starting position. Similarly, the control unit 58 may calculate (or estimate) a second distance value (SDV) between the current position and the predefined ending position. Each of the first distance value and the second distance value (hereinafter collectively referred to as operative distance values) may be calculated (or estimated) by aligning, or comparing, local maps with the route map (or the modified map) using any suitable techniques known in the art including, but not limited to, A* Search algorithm, Euclidean distance-based algorithms, and SLAM-based algorithms.

At step 510, the calculated (or estimated) operative distance values are compared with each other. In one embodiment, the control unit 58 may compare the calculated (estimated) first distance value with the calculated (estimated) second distance value to select one of the predefined operative positions. For instance, the control unit 58 may determine a selected position to be the starting position, at step 512, if the first distance value (FDV) may be less than or equal to the second distance value (SDV) Similarly, the control unit 58 may determine the selected position to be the ending position, at step 514, if the second distance value (SDV) may be less than the first distance value (FDV). The selected position may correspond to a closest operative position to the current position of the retrofitted scrubber 260.

At step 516, the control unit 58 may determine whether or not the current position may be within a preset minimum distance from the selected position. For example, when the predetermined starting position is the selected position, the control unit 58 may compare the first distance value with the preset minimum distance. Similarly, when the predetermined ending position is the selected position, the control unit 58 may compare the second distance value with the preset minimum distance. Examples of a value of the preset minimum distance include, but are not limited to, approximately 1 meter, approximately 2 meters, and approximately 3 meters. Some examples may include the value of the preset minimum distance being greater than approximately 3 meters.

If a distance value (i.e., selected distance value), e.g., FDV or SDV, of the selected position is less than or equal to the preset minimum distance, the control unit 58 may determine that the retrofitted scrubber 260 is located sufficiently close to the selected position and perform step 526, discussed below in greater detail. On the other hand, if the selected distance value is greater than the preset minimum distance, the control unit 58 may determine that the retrofitted scrubber 260 is located substantially away from the selected position and perform step 518.

At step 518, whether or not to drive the retrofitted scrubber 260 autonomously to the selected position is determined. In one embodiment, the control unit 58 may check for a pre-configuration when the retrofitted scrubber 260 may be substantially away from the selected position. For instance, the control unit 58 may be pre-configured to drive the retrofitted scrubber 260 autonomously to the selected position based on a set condition. Examples of the set condition may include, but are not limited to, (i) the selected distance value being greater than the preset minimum distance from the selected position, (ii) receiving an operator input via the interactive display unit 206, and (iii) receiving a trigger from a remote computing device. In some examples, the control unit 58 may send a request or message to a remote device for receiving such trigger or input. Examples of the remote device may include, but are not limited to, a fixed robot, a mobile robot, a display screen, a portable computing device, a handheld computing device, and a wearable computing device. In some examples, the remote device may be preconfigured to provide such trigger or input upon receiving the request. In the absence of such trigger/input or such pre-configuration, the control unit 58 to initiate step 522; otherwise, the control unit 58 may perform step 520.

At step 522, the control unit 58 may generate a control signal to perform one or more actions when the retrofitted scrubber 260 cannot be driven autonomously to the selected position. Examples of these actions may include, but are not limited to, (i) providing an indication (e.g., textual, audio, visual, haptic, or any combinations thereof), (ii) deactivating the autonomous mode or stopping any movement of the retrofitted scrubber 260, (iii) switching from the autonomous mode to the non-autonomous mode (or the training mode), (iv) shutting down the retrofitted scrubber 260, or any combinations thereof. In some examples, the indication may be sent to the interactive display unit 206 or a remote computing device. In some examples, the indication may encourage the operator to drive the retrofitted scrubber 260 to the selected position (or at least one of the operative positions), thereby enabling the control unit 58 to “repeat” the previously “learned” autonomous control and/or navigation of the retrofitted scrubber 260 along the learned route. The control signal (or the control unit 58) may cause to provide any suitable types of indications such as those mentioned above.

At step 524, a destination for autonomous navigation of the retrofitted scrubber 260 is set to NULL. In one embodiment, the control unit 58 may suspend autonomous navigation of the retrofitted scrubber 260 based on the control signal generated in step 522. Upon suspension, the control unit 58 may set a destination for autonomous navigation (hereinafter interchangeably referred to as auto-destination or “auto-destination” parameter) to NULL and again perform steps 506 to 518 depending on the underlying conditions. In one example, the auto-destination set to NULL may indicate to the control unit 58 (and/or to a remote device) that a destination for autonomous navigation of the retrofitted scrubber 260 needs to be re-calculated or re-set based on (i) a current position of the retrofitted scrubber 260 and (ii) a relative proximity between that current position and each of the predefined operative positions. In some examples, the control unit 58 may re-calculate or re-set the auto-destination after a predefined or dynamically defined check duration, e.g., at least approximately 30 seconds, at least approximately 60 seconds, at least approximately 90 seconds, at least approximately 120 seconds, etc. The check duration, in some examples, may depend on the distance between each of the predefined operative positions and the last determined/known position of the retrofitted scrubber 260.

On the other hand, the control unit 58 may set the selected position as the auto-destination, at step 520, upon receiving the required trigger/input to drive the retrofitted scrubber 260 autonomously to the selected position. In some examples, the control unit 58 may automatically set the auto-destination to be the selected position upon detecting that the retrofitted scrubber 260 is substantially away therefrom, i.e., the retrofitted scrubber 260 being located outside the preset minimum distance from the selected position.

At step 526, the control unit 58 may determine whether or not the retrofitted scrubber 260 is maintained in a neutral condition. In one embodiment, the control unit 58 may be configured to drive the retrofitted scrubber 260 autonomously provided one or more preconditions (or neutral conditions) for autonomous operation are met. The preconditions may indicate to the control unit 58 whether or not the neutral condition is maintained. In one example, the preconditions may include (i) the steering handle 204 maintained in the preset neural position and (ii) a preset scrubber surface (e.g., a scrubber platform such as the seat 16) maintained in the neutral state. The control unit 58 may determine a change in the neutral position (i.e., active rotation) of the steering handle 204 based on the steering signals received from the steering encoder 220. For example, the control unit 58 may calculate the angle of rotation of the steering handle 204 based on the steering signals, as discussed above, where the angle of rotation ranging from 0 degree to approximately 5 degrees may indicate the neutral position (or no substantial rotation) of the steering handle 204 to the control unit 58.

Further, the control unit 58 may determine a change in the preset neutral state of the preset scrubber surface, such as the seat 16, based on a detection signal from the presence sensor 186. The detection signal may indicate to the control unit 58 that a motion has been detected proximate to the preset scrubber surface. In some examples, the control unit 58 may additionally determine the neutral state of the seat 16 based on the seat sensor 28 (e.g., pressure sensor, heat sensor, etc.). The seat sensor 28 may provide no signal, or a signal having a value less than a predefined pressure threshold value, to indicate an absence of the operator from the seat 16. On the other hand, the seat sensor 28 providing a signal having a value equal to or greater than the predefined pressure threshold value may indicate a presence of the operator on the seat 16, thereby indicating a change in the neutral state of the seat 16.

Each of the preconditions (or neutral conditions) may ensure that there is no interference with the control unit 58 controlling the gearbox shaft 94 (and the drive shaft 50) autonomously due to any inadvertent movement of the steering unit 196 by the operator or a malfunction therein. Therefore, the preconditions, and hence, the neutral conditions, may assist in avoiding any interference with the autonomous operation of the retrofitted scrubber 260. If any of the neutral control is not maintained, the control unit 58 may execute step 522, as discussed above; else, the control unit 58 may execute step 528.

At step 528, whether or not the auto-destination is set as the selected position is checked. In one embodiment, the control unit 58 may check a current status of the “auto-destination” to determine a destination for driving the retrofitted scrubber 260 autonomously. The auto-destination set as the selected position may indicate that the retrofitted scrubber 260 is located substantially away from the selected position and that the control unit 58 cannot initiate to “repeat” the previously “learned” autonomous control and/or navigation of the retrofitted scrubber 260 along the learned route. If the auto-destination is set as the selected position, the control unit 58 may execute step 530, else the control unit 58 may execute step 532.

At step 530, the retrofitted scrubber 260 may be driven to the selected position autonomously. In one embodiment, the control unit 58 may be configured to drive the retrofitted scrubber 260 autonomously to the selected position based on the route map (or the global map) using any suitable localization and navigation techniques known in the art. For example, the control unit 58, in communication with the sensor system and the retrofitted encoders, may perform localization, preplanning, and planning and control functions for driving the retrofitted scrubber 260 autonomously. The control unit 58 may determine landmarks and other physical attributes in the surrounding environment using the sensor system to create local maps, which are then aligned (or compared) with the route map (or the global map) for localizing, or estimating a pose, of the retrofitted scrubber 260. Based on the pose estimate, the control unit 58 may generate a goal path for the retrofitted scrubber 260 using any of a variety of techniques known in the art including, but not limited to, the Time Elastic Bands (TEB) approach/algorithms. The goal path may be generated from the current position of the retrofitted scrubber 260 to the selected position (i.e., closest operative position) based on the route map (or the local map). Having accessed the route map (or the global map) and generated the goal path, the control unit 58 may drive the retrofitted scrubber 260 autonomously to move incrementally along the goal path from the current position to the selected position. While navigating autonomously to the selected position, the control unit 58 may scan the surrounding environment using the sensor system for any obstacles in the goal path and execute step 534.

At step 532, the auto-destination is set as an unselected position from the predefined operative positions. In one embodiment, the control unit 58 may set the auto-destination as an unselected position from the predefined operative positions when the auto-destination is not set as the selected position. In some examples, the control unit 58 change the auto-destination from NULL to the unselected position. In one example, the unselected position may correspond to a farthest position from the current position of the retrofitted scrubber 260. In another example, the unselected position may correspond to a farthest position from the selected position for the retrofitted scrubber 260. Other examples may include the unselected position corresponding to a new position between the predefined operative positions along the previously learned route. The new position may be selected by the operator and marked in the route map in a manner as discussed above. Further, the auto-destination set as NULL may indicate that the retrofitted scrubber 260 is located within the preset minimum distance from the selected position. In some examples, the auto-destination not set as the selected position may trigger the control unit 58 to “repeat” the previously “learned” autonomous control and/or navigation of the retrofitted scrubber 260 along the learned route in step 536.

At step 536, the control unit 58 may drive the retrofitted scrubber 260 autonomously from the current position to the unselected position set as the auto-destination. In the current position, the retrofitted scrubber 260 may be located within the preset minimum distance from the selected position. In one embodiment, the control unit 58, in communication with the sensor system and the retrofitted encoders, may drive the retrofitted scrubber 260 autonomously along the learned route from the current position, or the selected position such as the starting position, based on the accessed route maps using any suitable methodologies for localization, preplanning, and planning and control known in the art, as discussed above.

In another embodiment, the control unit 58 may be configured to “repeat” the learned route and the learned functions of the retrofitted scrubber 260 while driving the retrofitted scrubber 260 autonomously based on the “teach-and-repeat” method. For example, the control unit 58 may initiate or enable autonomous navigation of the retrofitted scrubber 260 along the learned route from the current position (or the selected position) only when the preconditions are determined to be satisfied, as discussed above. The control unit 58 may drive the retrofitted scrubber 260 autonomously based on the accessed navigation data including the motor data and the wheel data stored in the local data storage device or a remote device.

For autonomous navigation to the auto-destination (i.e., unselected position), in one embodiment, the control unit 58 may trigger the motor gearbox unit 92 to rotate the gearbox shaft 94 autonomously in the rotation directions based on the stored degree of rotations and the stored durations related thereto for driving the retrofitted scrubber 260 in the environment. When the stored degree of rotation may be positive, the control unit 58 may trigger a clockwise rotation of the gearbox shaft 94 via the electric motor 102 (or the motor gearbox unit 92). For example, the control unit 58 may trigger the electric motor 102 (or the motor gearbox unit 92) to produce a torque that rotates the gearbox shaft 94 by 35 degrees in the clockwise direction for 1 second when the stored degree of rotation may be 35 degrees and the related stored duration may be 1 second. Similarly, when the stored degree of rotation may be negative, the control unit 58 may trigger an anti-clockwise rotation of the gearbox shaft 94 via the electric motor 102 (or the motor gearbox unit 92). For example, the control unit 58 may trigger the electric motor 102 (or the motor gearbox unit 92) to produce a torque that rotates the gearbox shaft 94 by 35 degrees in the anti-clockwise direction for 0.8 seconds when the stored degree of rotation may be negative (−) 35 degrees and the related stored duration may be 0.8 seconds. In a further example, the control unit 58 may not trigger the electric motor 102 (or the motor gearbox unit 92) to prevent any rotation of the gearbox shaft 94 for 5 seconds when the stored degree of rotation may be 0 degrees and the related stored duration may be 5 seconds.

Based on the autonomous rotation of the gearbox shaft 94, the motor encoder 96 may generate current motor signals. For instance, the motor encoder 96 may generate a first current motor signal based on each autonomous clockwise rotation of the gearbox shaft 94 and a second current motor signal based on each autonomous anti-clockwise rotation of the gearbox shaft 94. In one example, the control unit 58 may calculate a first current angle of rotation based on the first current motor signal, and calculate a second current angle of rotation based on the second current motor signal e.g., using Equation 1 as discussed above. In some examples, the control unit 58 may compare each of the first current angle of rotation and the second current angle of rotation (hereinafter collectively referred to as current angles of rotation) with the respective stored degrees of rotations used to trigger the autonomous rotation of the gearbox shaft 94. The control unit 58 may verify the gearbox shaft 94 being rotated up to the correct degree of rotation and in the correct direction if there is a match between the current angles of rotation (and associated durations) and the respective stored degrees of rotation (and associated durations) based on the comparison.

The rotating gearbox shaft 94 may, in turn, rotate the drive shaft 50 connected to the drive wheel 30, e.g., the front wheel. The clockwise rotation of the gearbox shaft 94 may rotate the drive shaft 50 clockwise, thereby turning the drive wheel 30 rightward with respect to the vertical axis of the drive shaft 50 (or the retrofitted scrubber 260). Similarly, the anti-clockwise rotation of the gearbox shaft 94 may rotate the drive shaft 50 anti-clockwise, thereby turning the drive wheel 30 leftward with respect to the vertical axis of the drive shaft 50 (or the retrofitted scrubber 260). The rightward and the leftward turning of the drive wheel 30 may assist in steering the retrofitted scrubber 260 during autonomous navigation.

As the retrofitted scrubber 260 moves autonomously, the control unit 58 may also monitor and control the wheel spin of the drive wheel 30 based on the stored wheel data to assist in navigation and avoiding collision with any obstacles along the learned route. For example, based on the wheel spin of the drive wheel 30, the wheel encoder 254 may generate a first current wheel signal based on a forward spin, and a second current wheel signal based on a reverse spin of the drive wheel 30, during the autonomous navigation. The control unit 58 may measure the current number of forward rotations (and/or speed of forward rotation) of the drive wheel 30 based on the first current wheel signal and the current number of backward rotations (and/or speed of backward rotation) based on the second current wheel signal.

Each of the current number of forward rotations (and/or speed of forward rotation) and the current number of backward rotations (and/or speed of backward rotation) may be compared with the stored number of forward rotations (and/or speed of forward rotation) and the stored number of backward rotations (and/or speed of backward rotation) respectively. The control unit 58 may confirm the drive wheel 30 being moved up to the correct number of rotations and in the correct direction (and at the correct speed) if there is a match based on the comparison. The comparison may assist in ensuring that the distance of travel and the speed of travel (e.g., based on the number of wheel rotations or spins) of the retrofitted scrubber 260 are the same as those taught to the control unit 58 by the operator during the training mode. For example, the control unit 58 may control the power supplied, via the transmission system, to the drive wheel 30 for ensuring that the drive wheel 30 may have a wheel spin equivalent to 5 rotations in the forward direction at the speed of 2 meters per second (m/s) when the stored number of forward rotations may be 5, and the stored speed of forward rotation related thereto may be 2 m/s. The control unit 58 may also autonomously maneuver the brakes, via the brake actuator 72, to control or stop the drive wheel 30, and hence the retrofitted scrubber 260, in response to detection of any obstacles within a safe distance (e.g., the short safe distance and/or the long safe distance) by the sensor system, discussed below in greater detail.

Further, the control unit 58 may drive the retrofitted scrubber 58 autonomously along the learned route while performing previously learned task-related functions of the retrofitted scrubber 260. In one embodiment, the task-related functions may correspond to activation or deactivation of one or more components of the scrubber assembly to perform a cleaning task. For example, the control unit 58 may actuate the scrubber actuator 74 to manipulate the brush unit 34 while autonomously driving the retrofitted scrubber 260 along the learned route. The control unit 58 may generate a first scrubber signal autonomously at the first scrubber position, which may be correlated with the stored real-world position and the respective stored navigation data of the retrofitted scrubber 260. Based on the first scrubber signal, the control unit 58 may actuate the scrubber actuator 74 for driving the brush unit 34 to engage the brushes 36 with a surface such as the floor for cleaning. The brushes 36 may be engaged with the floor for the stored brush duration. Other examples may include the scrubber actuator 74 activating the vacuum unit in the scrubber assembly based on the first scrubber signal. Similarly, the control unit 58 may generate a second scrubber signal autonomously at the second scrubber position, which may be correlated with the stored real-world position and the respective stored navigation data of the retrofitted scrubber 260. Based on the second scrubber signal, the control unit 58 may actuate the scrubber actuator 74 for driving the brush unit 34 to disengage the brushes 36 from the surface such as the floor. The brushes 36 may be disengaged from the floor for the stored unbrush duration. Other examples may include the scrubber actuator 74 deactivating the vacuum unit in the scrubber assembly based on the second scrubber signal.

In another embodiment, the control unit 58 may perform the task-related functions autonomously in response to a sensor while driving the retrofitted scrubber 260 autonomously along the learned route. For example, the control unit 58 may scan the floor and/or a wheel (e.g., the non-drive wheels 32) of the retrofitted scrubber 260 for any contamination, such as dirt, debris and/or spillage, using the cleaning sensor 234. As illustrated in FIG. 47, the cleaning sensor 234 may have a field of view covering a portion of at least one of the non-drive wheels 32, e.g., rear wheels, and a portion of the floor. When the cleaning sensor 234 detects any dirt, debris and/or spillage above a preset contamination threshold value on the ground and/or a wheel such as the non-drive wheel 32-1 (or rear wheel), the control unit 58 may generate a first scrubber signal to drive the scrubber actuator 74 autonomously. The scrubber actuator 74, in one example, may drive the brush unit 34 based on the first scrubber signal to lower the brush unit 34 for engaging the brushes 36 with the floor to be cleaned. In some examples, the brush unit 34 may include the rotatory brushes. The control unit 58 also activate the rotation of the rotatory brushes based on the first scrubber signal while lowering the brush unit 34 to engage the rotatory brushes with the floor. In further examples, the control unit 58 may stop, or inhibit the speed, of the retrofitted scrubber 260, via the brake actuator 72 as discussed above, while the brushes 36 are being deployed.

In other examples, the control unit 58 may be further configured to increase the power supplied to the cleaning components (e.g., brush unit 34, rotatory brushes, vacuum unit, squeegee assembly, etc.) based on a contamination level, or an extent of unclean portion of the floor surface, being greater than the preset contamination threshold value. The contamination level, or the unclean portion, may be detected by the cleaning sensor 234 operating in communication with the control unit 58. In one example, the control unit 58 may increase the power supplied to the brush unit 34 to increase a speed of rotation of the rotatory brushes to rigorously scrub a floor surface. In another example, the control unit 58 may increase the power supplied to the vacuum unit to increase the suction power thereof for effectively and quickly cleaning the unclean portion of the floor. The extent of unclean portion may be determined by the control unit 58, in communication with the cleaning sensor 234 and the retrofitted encoders (e.g., wheel encoder 254), based on, at least one of, (i) a number of rotations/spins of a wheel (e.g., drive wheel 30) covered in contamination such as dirt, debris, and/or spillage above the preset contamination threshold value, (ii) a distance travelled by the retrofitted scrubber 260 being greater than a preset contaminated distance threshold value, where such distance is covered by the retrofitted scrubber 260 with the wheels or the underlying floor surface covered in dirt, debris, and/or spillage exceeding the preset contamination threshold value, and (iii) a portion (or area) of the floor greater than a preset contaminated area threshold value along the learned route, where the portion may be covered in dirt, debris, and/or spillage exceeding the preset contamination threshold value.

Similarly, when the cleaning sensor 234 may detect dirt, debris and/or spillage below the preset contamination threshold value, or a lesser level of unclean portion, the control unit 58 may generate the second scrubber signal to drive the scrubber actuator 74 autonomously. The scrubber actuator 74, in one example, may drive the brush unit 34 based on the second scrubber signal to raise the brush unit 34 upwards for disengaging the brushes 36 from the floor. In some examples where the brush unit 34 may include the rotatory brushes, the control unit 58 may also deactivate the rotation of the rotatory brushes based on the second scrubber signal while disengaging the rotatory brushes from the floor. In some examples, the control unit 58 may be further configured to decrease or stop the power supplied to the cleaning components based on the level of unclean portion of the floor detected by the cleaning sensor 234 being below a threshold value. For instance, the control unit 58 may inhibit the power supplied to the brush unit 34 to decrease or stop the speed of rotation of the rotatory brushes. In another example, the control unit 58 may maintain, or stop, the power supplied to the vacuum unit to maintain, or stop, the suction power thereof.

At step 534, the control unit 58 may scan the environment using on or more sensors from the sensor system while driving the retrofitted scrubber 260 autonomously. For example, the LIDAR sensor 232, the box sensors, and the auxiliary sensors 262 (hereinafter collectively referred to as field sensors) may scan the ambient environment to detect any obstacles in a driving path of the retrofitted scrubber 260 navigating autonomously. In one example, the driving path may refer to the goal path in case of the retrofitted scrubber 260 navigating autonomously to the selected position, as discussed above with respect to step 530. In another example, the driving path may refer to the learned route followed by the retrofitted scrubber 260 while navigating autonomously to the unselected position. If the field sensors detect any obstacles within a preset safe distance (e.g., ranging from approximately 0.5 meters to approximately 2 meters) therefrom during the autonomous navigation, the control unit 58 may perform step 538. Else, the control unit 58 may initiate step 540 for the retrofitted scrubber 260 to continue moving forward.

At step 538, the control unit 58 may perform one or more actions based on an obstacle being detected by the field sensors. In one embodiment, the control unit 58 may trigger the brake actuator 72 to inhibit or slow down, change a pose, and/or a direction of motion of the retrofitted scrubber 260 when the LIDAR sensor 232 may detect objects in the driving path within a long safe distance, S1, (e.g., approximately 2 meters) from the retrofitted scrubber 260 as shown in FIG. 47. In some examples, the control unit 58 may trigger the brake actuator 72 to completely stop the motion of the retrofitted scrubber 260 when the front sensor 184 in the integrated steering column 70 or any of the other box sensors and/or the auxiliary sensors 262 may detect obstacles within a short safe distance, S2, (e.g., approximately 0.5 meters) from the retrofitted scrubber 260. In some examples, the control unit 58 may wait until at least the short safe distance, S2, becomes clear and free from any obstacles or trigger a change in the pose of the retrofitted scrubber 260 to detour around the obstacle for reinitiating a forward motion of the retrofitted scrubber 260. In a further example, the control unit 58 may wait until the long safe distance, S1, alone or in combination with the short safe distance, S2, becomes clear and free of any obstacles to reinitiate a forward motion of the retrofitted scrubber 260.

In another embodiment, the control unit 58 may provide an indication based on any of the field sensors detecting an obstacle. In some examples, the indication may be sent to the interactive display unit 206 or a remote computing device. Other examples may include the control unit 58 causing to provide any suitable types of indications such as those mentioned above. In a further embodiment, the control unit 58 may inhibit or stop a predefined or dynamically defined task-related function of the retrofitted scrubber 260. For example, the control unit 58 may be configured to (i) trigger the onboard power source 8 (e.g., batter, ICE, etc.) for reducing the power supplied to the transmission system for decelerating the drive wheel 30, (ii) apply brake, via the brake actuator 72, for stopping or inhibiting the speed of the drive wheel 30 and hence, the retrofitted scrubber 260, and (iii) actuate the scrubber actuator 74 to autonomously disengage the brush unit 34 and/or decrease (or stop) the power supplied to the cleaning components. As the retrofitted scrubber 260 continues to move autonomously, the control unit 58 may check whether or not the retrofitted scrubber 260 has reached the auto-destination at step 542.

At step 542, the control unit 58 may check whether or not the auto-destination is reached while driving the retrofitted scrubber 260 autonomously. The auto-destination may be either the selected position via a generic goal path or the unselected position via the previously learned route, as discussed above. In one example, if the last set auto-destination is yet to be reached by the retrofitted scrubber 260, the control unit 58 may again perform steps 526 to 542 depending on the underlying conditions. Else, if the retrofitted scrubber 260 has reached the last set auto-destination, the control unit 58 may execute step 544.

At step 544, whether or not the auto-destination is set as the unselected position is checked. In one embodiment, the control unit 58 may check a current status of the “auto-destination” to determine whether or not the retrofitted scrubber 260 has repeated the previously learned task-related functions while moving autonomously along the previously learned route. The auto-destination set as the unselected position may indicate that the retrofitted scrubber 260 has completed a travel between the predefined operative positions while moving autonomously along the learned route. If the auto-destination is set as the unselected position, the control unit 58 stop the movement of the retrofitted scrubber 260. Else, the control unit 58 may execute step 532 to “repeat” the previously “learned” autonomous control and/or navigation of the retrofitted scrubber 260 to the unselected position along the learned route.

In some examples, based on the retrofitted scrubber 260 completing the autonomous navigation along the learned route or reaching (or returning) to one of the operative positions, the control unit 58 may (i) provide any suitable indication, such as those mentioned above, and/or (ii) deactivate the autonomous mode. Other examples may include the control unit 58 providing an indication based on the retrofitted scrubber 260 being stationary at a specific location or in a specific orientation (e.g., due to obstacles) for a duration greater than the predefined time threshold value.

In further examples, based on the preconditions, as discussed above, being violated or failed, the control unit 58 may be configured to (i) provide an indication (e.g., textual, audio, visual, haptic, or a combination thereof) for the operator, (ii) stop the autonomous mode (or the autonomous navigation) of the retrofitted scrubber 260, (iii) switch to the non-autonomous mode or the training mode, and/or (iv) shut down the retrofitted scrubber 260, or any combinations thereof, at any time during the autonomous mode (or the autonomous navigation) of the retrofitted scrubber 260.

While the foregoing written description of the invention would enable one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiments, methods, and examples, disclosed in the present application.

I/We claim:

1. A vehicle, comprising:
a chassis;
a drive shaft mounted to the chassis, wherein the drive shaft is connected to a drive wheel;
an integrated steering column mounted to the chassis, wherein the integrated steering column is operably connected to the drive shaft for steering the drive wheel; and
a set of proximity sensors mounted to the integrated steering column, the set being configured to scan an ambient environment, wherein the set includes a first proximity sensor and a second proximity sensor respectively oriented towards each of the opposing lateral sides of the chassis.

2. The vehicle of claim 1, wherein the set includes a third proximity sensor oriented in a direction orthogonal to a direction of orientation of at least one of the first proximity sensor and the second proximity sensor.

3. The vehicle of claim 2, wherein the integrated steering column further comprises a presence sensor configured to detect a change in a neutral state of the preset surface of the vehicle, the neutral state corresponding to at least one of a stationary object and an absence of motion proximate to the preset surface, wherein the presence sensor is located opposite to the third proximity sensor.

4. The vehicle of claim 1, further comprising a cleaning sensor mounted to the chassis, the cleaning sensor being oriented towards a surface proximate to the vehicle, wherein the cleaning sensor is configured to detect a contamination on the surface.

5. The vehicle of claim 4, wherein the surface comprises at least one of a floor and a portion of a non-drive wheel of the vehicle.

6. The vehicle of claim 4, wherein the cleaning sensor is oriented at an angle of 45 degrees with respect to a horizontal axis of the chassis.

7. The vehicle of claim 1, the integrated steering column further comprises:
a steering handle rotatable from a neutral position for manual steering of the vehicle;
a steering encoder operably connected to the steering handle, wherein the steering encoder is configured to generate a steering signal based on a rotation of the steering handle;
a local shaft coupled with the drive shaft for a conjoint rotation;
a motor operably connected to the local shaft, wherein the motor is configured to provide a torque for rotating the local shaft;
a motor encoder operably connected to the local shaft, wherein the motor encoder is configured to generate a motor signal based on a rotation of the local shaft; and
a control unit for driving the vehicle based on predefined modes of operation including a training mode and an autonomous mode, wherein the control unit is configured to:
in the training mode,
record a starting position of the vehicle for navigation, wherein the starting position corresponds to a position where the training mode is activated;
drive the motor based on the steering signal for rotating the local shaft, wherein the local shaft in turn rotates the drive shaft for steering the drive wheel during navigation of the vehicle from the starting position;
calculate motor data based on the motor signal generated upon a rotation of the local shaft, wherein the motor data includes at least one of an angle of rotation of the local shaft and a duration of rotation of the local shaft;
calculate wheel data using a wheel signal generated by a wheel encoder based on a spin of the drive wheel during navigation of the vehicle, the wheel encoder being mounted to a measuring wheel in contact with the drive wheel, wherein the wheel data includes at least one of a number of wheel spins and a speed of rotation of the drive wheel;
record an ending position of the vehicle, wherein the ending position corresponds to a position where the training mode is deactivated; and
record a route travelled by the vehicle from the starting position to the ending position, wherein the route is recorded in terms of the motor data and the wheel data; and
in the autonomous mode,
spin the drive wheel based on the calculated wheel data for autonomously driving the vehicle from the recorded starting position to the recorded ending position along the recorded route; and
rotate the local shaft based on the calculated motor data for autonomously steering the vehicle via the drive shaft connected to the drive wheel.

8. The vehicle of claim 7, wherein the steering handle is set at an angle ranging from 0 degree to 5 degrees with respect to a vertical axis of the integrated steering column in the neutral position.

9. The vehicle of claim 7, wherein the integrated steering column further comprises:
a centering mechanism operably connected to the steering handle, the centering mechanism being configured to bias the steering handle towards the neutral position based on a rotation of the steering handle with respect to a vertical axis of the integrated steering column, wherein the centering mechanism is non-motorized.

10. A retrofit kit for use on a vehicle, the retrofit kit comprising:
an integrated steering column mountable on a chassis of the vehicle and configured to assist in steering the vehicle, the integrated steering column including a set of proximity sensors configured to scan an ambient environment, wherein the set includes a first proximity sensor and a second proximity sensor respectively oriented towards each of the opposing lateral sides of the vehicle; and
a coupler configured to mechanically connect the integrated steering column with a drive shaft mounted to the chassis, the drive shaft being connected to a drive wheel of the vehicle, wherein the coupler enables a transfer of torque from the integrated steering column to the drive shaft for steering the vehicle.

11. The retrofit kit of claim 10, wherein the set further comprises a third proximity sensor oriented in a direction orthogonal to a direction of orientation of at least one of the first proximity sensor and the second proximity sensor.

12. The retrofit kit of claim 11, wherein the set further comprises a presence sensor configured to detect a change in a neutral state of a preset surface of the vehicle, the neutral state corresponding to at least one of a stationary object and an absence of motion proximate to the preset surface, wherein the presence sensor is located opposite to the third proximity sensor.

13. The retrofit kit of claim 10, further comprising a cleaning sensor configured to detect a contamination on a surface including at least one of a floor and a portion of a non-drive wheel of the vehicle.

14. The retrofit kit of claim 13, wherein the cleaning sensor is configured for being mounted to the chassis at an angle of 45 degrees with respect to a horizontal axis of the chassis.

15. The retrofit kit of claim 10, further comprising:
a scrubber actuator configured to electronically control a brush unit movably connected to the vehicle, the brush unit including brushes, wherein the scrubber actuator operates to raise or lower the brushes with respect to a floor; and
a brake actuator configured to electronically actuate brakes mounted to a drive wheel of the vehicle, wherein the brake actuator and the scrubber actuator are adapted to operate in communication with a control unit mounted on the integrated steering column.

16. The retrofit kit of claim 10, wherein the integrated steering column further comprises:
a steering handle configured to assist in manually steering the vehicle, wherein the steering handle is configured to rotate clockwise and anti-clockwise from a neutral position; and
a centering mechanism operably connected to the steering handle, the centering mechanism being configured to bias the steering handle towards the neutral position based on a rotation of the steering handle with respect to a vertical axis of the integrated steering column, wherein the centering mechanism is non-motorized.

17. An integrated steering column for a vehicle, the integrated steering column comprising:
a motor assembly including a local shaft adapted to couple with a drive shaft of the vehicle, the motor assembly being configured to provide a torque to the local shaft, wherein the local shaft is rotatable based on the torque to rotate the drive shaft connected to a drive wheel of the vehicle; and
a set of proximity sensors configured to scan an ambient environment, the set including a first proximity sensor oriented towards a first direction and a second proximity sensor oriented towards a second direction, wherein the first direction is opposite to the second direction.

18. The integrated steering column of claim 17, further comprising:
a steering handle configured to assist in manually steering the vehicle, wherein the steering handle is configured to rotate clockwise and anti-clockwise from a neutral position; and
a centering mechanism operably connected to the steering handle, the centering mechanism being configured to bias the steering handle towards the neutral position based on a rotation of the steering handle with respect to a vertical axis of the integrated steering column, wherein the centering mechanism is non-motorized.

19. The integrated steering column of claim 17, wherein the set further includes a third proximity sensor oriented in a third direction orthogonal to at least one of the first direction and the second direction.

20. The integrated steering column of claim 19, wherein the set further comprises a presence sensor configured to detect a change in a neutral state of a preset surface of the vehicle, the neutral state corresponding to at least one of a stationary object and an absence of motion proximate to the preset surface, wherein the presence sensor is located opposite to the third proximity sensor.
